(19) United States
(12) Patent Application Publication
(10) Pub. No.: US 2014/0168195 A1
(43) Pub. Date: Jun. 19, 2014

(54) ELECTRO-OPTIC DEVICE AND DRIVING METHOD THEREOF

(71) Applicant: SAMSUNG DISPLAY CO., LTD., Yongin-City (KR)

(72) Inventors: Masayuki KUMETA, Yokohama (JP); Takeshi OKUNO, Yokohama (JP); Eiji KANDA, Yokohama (JP); Ryo ISHII, Yokohama (JP); Naoaki KOMIYA, Yokohama (JP)

(73) Assignee: SAMSUNG DISPLAY CO., LTD., Yongin-City (KR)

(21) Appl. No.: 14/105,936

(22) Filed: Dec. 13, 2013

(30) Foreign Application Priority Data
Dec. 14, 2012 (JP) 2012-274074

(51) Int. Cl. G09G 3/32

(52) U.S. Cl. CPC G09G 3/3258
USPC 345/212

(57) ABSTRACT

A pixel circuit includes a driving transistor connected to a light-emitting element and capacitor connected to a gate of the driving transistor. A threshold voltage of the driving transistor is compensated during a first period based on a first voltage derived from a power supply voltage. The gate of the driving transistor is set to a second voltage during a second period, where the second voltage is derived from a data voltage stored in the capacitor. The second period includes a data program period. An operation of the pixel circuit in the first period is performed independently from an operation of the pixel circuit in the data program period. Accordingly, threshold voltage compensation and data program operations are performed in separate periods based on different voltages supplied to the driving transistor.

### CROSS-REFERENCE TO RELATED APPLICATION

Japanese Patent Application No. 2012-274074, filed on Dec. 14, 2012, and entitled, “Electro-Optic Device and Driving Method Thereof,” is incorporated by reference herein in its entirety.

### BACKGROUND

1. Field

One or more embodiments described herein relate to an electro-optic device.

2. Description of the Related Art

An electro-optic device uses an element (e.g., an organic electroluminescence element) to emit a light having an intensity that corresponds to a supplied current. The magnitude of this current is controlled by a driving transistor provided for each pixel. Controlling this driving transistor allows a desired gradation of a display image to be displayed on a pixel-by-pixel basis.

If the characteristics of the driving transistors vary, the quality of the displayed image is adversely affected. This may occur, for example, when the threshold voltages of the driving transistors vary or are inconsistent with one another. This may also occur as a result of different process variations of the driving transistors.

### SUMMARY

In accordance with one embodiment, a method of driving at least one pixel circuit of an electro-optic device includes at least four operations. A first operation is a reset operation which includes connecting a first transistor to a gate of a driving transistor that is turned on and an initial voltage to reset a gate voltage of the driving transistor, the initial voltage at a level lower than a voltage of a data signal to be provided to the gate of the driving transistor.

A second operation is a threshold voltage compensation operation which includes connecting a drain and the gate of the driving transistor when a second transistor connected between the drain and gate of the driving transistor is turned on, applying a first voltage to a data signal line connected to a source of the driving transistor, supplying a second voltage to the gate of the driving transistor, the second voltage varied from the first voltage by a threshold voltage of the driving transistor, the gate voltage of the driving transistor changing from the initial voltage to the second voltage, and holding the second voltage of the driving transistor in a capacitive element having a first terminal connected to the gate of the driving transistor.

A third operation is a data program operation which includes providing a set voltage at a low level to a second terminal of the capacitive element, providing a data voltage to the data signal line based on a gate potential of the driving transistor that is lower than a potential of the data signal, providing a third voltage to the gate of the driving transistor, the third voltage varied from the data voltage by the threshold voltage of the driving transistor, and holding the third voltage in the capacitive element.

A fourth operation includes performing a light-emitting operation including providing the first voltage to the data signal line and providing a drain current according to the third voltage corresponding to the gate voltage of the driving transistor to a light-emitting element, the drain current provided by turning on a light-emitting control transistor connected between the drain of the driving transistor and a positive electrode of the light-emitting element. The first voltage may be a power supply voltage of a positive electrode side of the light-emitting element.

In accordance with another embodiment, a method of driving at least one pixel circuit of an electro-optic device includes at least three operations. A first operation is a reset operation which includes turning on a first transistor connected to a gate of a driving transistor of a pixel circuit and providing an initial voltage lower than a voltage of a first data signal to the gate of the driving transistor to reset a gate voltage of the driving transistor.

A second operation is a threshold voltage compensation operation which includes connecting a drain and the gate of the driving transistor by turning on a second transistor connected between the drain and the gate of the driving transistor, applying a first voltage to a data signal line connected to a source of the driving transistor, providing a second voltage to the gate of the driving transistor, the second voltage varied from the first voltage by a threshold voltage of the driving transistor, and holding the second voltage of the driving transistor in a capacitive element having a first terminal connected to the gate of the driving transistor.

A third operation includes performing a data program operation which includes providing a set voltage at a low level a second terminal of the capacitive element, providing a data voltage to the data signal line based on a gate potential of the driving transistor that is lower than a potential of the first data signal, providing a third voltage to the gate of the driving transistor, the third voltage varied from the data voltage by the threshold voltage of the driving transistor, and holding the third voltage in the capacitive element.

After the reset operation, threshold voltage compensation operation, and data program operation are performed for a plurality of pixel circuits, the method includes providing the first voltage to the data signal line, and providing a drain current to a light-emitting element, the drain current based on the third voltage being the gate voltage of the driving transistor, the drain current provided to the light-emitting element by turning on a light-emitting control transistor connected between the drain of the driving transistor and a positive electrode of the light-emitting element, wherein the light-emitting elements of the pixel circuits emit light at substantially a same time. The first voltage may be a power supply voltage of a positive electrode side of the light-emitting element.

In accordance with another embodiment, a method of driving at least one pixel circuit of an electro-optic device includes at least four operations. A first operation is a reset operation which includes turning on a first transistor connected to a gate of a driving transistor and providing an initial voltage at a level lower than a voltage of a data signal to the gate of the driving transistor to reset a gate voltage of the driving transistor.

A second operation is a threshold voltage compensation operation including connecting a drain and the gate of the driving transistor by turning on a second transistor connected between the drain and the gate of the driving transistor, applying a first voltage to a source of the driving transistor from a power line by turning on a third transistor connected between the source of the driving transistor and a power line supplied with a power supply voltage, providing a second voltage to the gate of the driving transistor, the second voltage varied from the first voltage by a threshold voltage of the driving transistor, the gate voltage of the driving transistor changing from the initial voltage to the second voltage, and holding the second voltage of the driving transistor in a capacitive element having a first terminal connected to the gate of the driving transistor.

A third operation is a data program operation including providing a set voltage at a low level to a second terminal of the capacitive element, setting a gate potential of the driving transistor to be lower than a potential of the data signal, providing a third voltage to the gate of the driving transistor, the third voltage varied from the data voltage by the threshold voltage of the driving transistor, the third voltage provided by turning on a fourth transistor connected between the source of the driving transistor and a data signal line, and holding the third voltage in the capacitive element.

A fourth operation is a light-emitting operation which includes providing the first voltage to the driving transistor from the power line, the first voltage provided by turning on the third transistor and a drain current, the third voltage corresponding to the gate voltage of the driving transistor, and turning on a current light-emitting element by turning on a light-emitting control transistor connected between the drain of the driving transistor and a positive electrode of the light-emitting element.

In accordance with another embodiment, a method of driving at least one pixel circuit of an electro-optic device includes at least three operations. A first operation is a reset operation which includes turning on a first transistor connected to a gate of a driving transistor of the pixel circuit and providing an initial voltage to the gate of the driving transistor to reset a gate voltage of the driving transistor, the initial voltage at a level lower than a voltage of a first data signal.

A second operation is a threshold voltage compensation operation including connecting a drain and the gate of the driving transistor by turning on a second transistor connected between the drain and the gate of the driving transistor, applying a first voltage to a source of the driving transistor from a power line by turning on a third transistor connected between the source of the driving transistor and the power line, the power line supplied with a power supply voltage, providing a second voltage to the gate of the driving transistor, the second voltage varied from the first voltage by a threshold voltage of the driving transistor, the gate voltage of the driving transistor changing from the initial voltage to the second voltage, and holding the second voltage of the driving transistor in a capacitive element having a first terminal connected to the gate of the driving transistor.

A third operation is a data program operation which includes providing a set voltage at a low level to a second terminal of the capacitive element, setting a gate potential of the driving transistor to be lower than a potential of the first data signal, providing a third voltage to the gate of the driving transistor, the third voltage varied from the data voltage by the threshold voltage of the driving transistor, the third voltage provided by turning on a fourth transistor connected between the source of the driving transistor and the data signal line, and holding the third voltage in the capacitive element.

After the reset operation, threshold voltage compensation operation, and data program operation are performed for a plurality of pixel circuits, the method includes providing the first voltage to the driving transistor from the power line by turning on the third transistor of each of the plurality of pixel circuits, and providing drain current to the light-emitting elements of the pixel circuits based on the third voltage being the gate voltage of the driving transistor, the drain current provided by turning on a light-emitting control transistor connected between the drain of the driving transistor and a positive electrode of the light-emitting element in each of the pixel circuits, wherein the current light-emitting elements of the plurality of pixel circuits emit light at substantially a same time.

In accordance with another embodiment, an electro-optic, device includes a driving transistor having a source connected to a data line and a gate connected to receive a data signal during a program operation, the data signal provided from the data line and corresponding to gradation value, the gate of the driving transistor receiving the data signal while the driving transistor is diode-connected; and a light-emitting element connected to the driving transistor and supplied with a drain current based on a gate voltage of the driving transistor, wherein an initial value of the gate voltage is determined based on a detected threshold voltage of the driving transistor, and wherein the initial value of the gate voltage is determined and the threshold voltage of the driving transistor is detected before a data program operation is performed.

The threshold voltage of the driving transistor may be detected based on a power supply voltage applied to a positive electrode side of the light-emitting element. Also the electro-optic device may include a capacitive element having a first electrode to receive a set voltage during the data program operation and a second electrode connected to the gate of the driving transistor, wherein a gate potential of the driving transistor is set to be lower than a potential of the data signal during the data program operation.

In accordance with another embodiment, a pixel circuit includes a driving transistor connected to a light-emitting element; and a capacitor connected to a gate of the driving transistor, wherein a threshold voltage of the driving transistor is compensated during a first period based on a first voltage, the first voltage based on a power supply voltage, wherein the gate of the driving transistor is set to a second voltage during a second period, the second voltage based on data voltage stored in the capacitor, and wherein the first period is independent from the second period.

A data program operation may be performed during the second period, and the data program operation may be performed independently from the threshold voltage compensation during the first period.

A data signal corresponding to the data voltage and the power supply voltage may be received on a same signal line at different times. A data signal corresponding to the data voltage and the power supply voltage may be carried along different signal lines. The driving transistor may be in a diode-connected state during the first period.

The data-signal may be written to the gate of the driving transistor while the driving transistor is in a diode-connected state. A potential of the gate of the driving transistors may be lowered before the data voltage is stored in the capacitor. The gate potential may be lowered based on a difference between a set voltage and a bias voltage. The data voltage stored in the capacitor may be written to the gate of the driving transistor after the gate potential of the driving transistor is lowered.

The capacitor may be connected between the driving transistor and a signal line that receives the bias voltage. The gate of the driving transistor may be set to an initial voltage during a third period which occurs before the first and second periods. The capacitor may store the data voltage independently from a signal line carrying a data signal corresponding to the data voltage and the power supply voltage. The pixel circuit may have a total of four transistors including the driving transistor.

### BRIEF DESCRIPTION OF THE DRAWINGS

Features will become apparent to those of ordinary skill in the art by describing in detail exemplary embodiments with reference to the attached drawings in which:

FIG. 1 illustrates a first embodiment of a pixel circuit;

FIG. 2 illustrates a first embodiment of a method for driving the pixel circuit;

FIG. 3 illustrates operation the pixel circuit in different driving periods;

FIGS. 4A-4D illustrate states of the pixel circuit in the different driving periods;

FIG. 5 illustrates a display panel with a plurality of the pixel circuits;

FIG. 6 illustrates operation of the display panel in different driving periods;

FIG. 7A illustrates operation of pixel circuits which have been proposed, and

FIG. 7B illustrates operation of pixel circuits of the first embodiment;

FIG. 8 illustrates operation of a second embodiment of a pixel circuit in a vertical period;

FIG. 9 illustrates operation of the second embodiment of the pixel circuit in a horizontal period;

FIG. 10 illustrates a display panel with pixel circuits of the second embodiment;

FIG. 11 illustrates operation of the second embodiment of the pixel circuit in different driving periods;

FIG. 12 illustrates a third embodiment of a pixel circuit;

FIG. 13 illustrates operation of the third embodiment of the pixel circuit in different driving periods;

FIG. 14 illustrates a display panel with pixel circuits of the third embodiment;

FIG. 15 illustrates operation of the third embodiment of the pixel circuit in different driving periods of a vertical period;

FIG. 16 illustrates operation of the third embodiment of the pixel circuit;

FIG. 17 illustrates a fourth embodiment of a pixel circuit;

FIG. 18 illustrates operation of the fourth embodiment of the pixel circuit in different driving periods;

FIGS. 19A-19D illustrate states of the pixel circuit of the fourth embodiment during the different driving periods;

FIG. 20 illustrates a display panel with pixel circuits of the fourth embodiment;

FIG. 21 illustrates operation of the display panel including pixel circuits of the fourth embodiment;

FIG. 22 illustrates a proposed pixel circuit; and

FIG. 23 illustrates operation of the proposed pixel circuit.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the figures, the dimensions of layers and regions may be exaggerated for illustrative purposes. When a layer or element is referred to as being “on” another layer or substrate, it can be directly on the other layer or substrate, or intervening layer(s) may be present. It will also be understood that when a layer is referred to as being “under” another layer, it can be directly under or one or more intervening layers may be present. It will also be understood that when a layer is referred to as being “between” two layers, it can be the only layer between the two layers, or one or more intervening layers may be present. Like reference numerals refer to like elements throughout.

### Overview

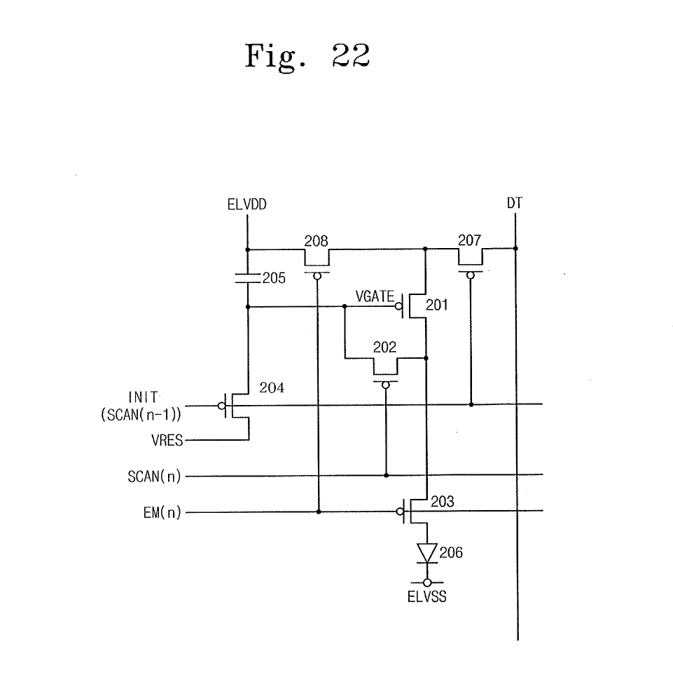

FIG. 22 illustrates one type of pixel circuit for use in a light-emitting element. This pixel circuit includes a driving transistor 201, a switching transistor 202 for connecting a drain and gate of driving transistor 201, a reset transistor 204 providing a gate of the driving transistor 201 with an initial voltage, a capacitor 205, light-emitting control transistors 203 and 208 for controlling a connection between the current light-emitting element 206 and a power source voltage ELVDD, and a selection transistor 207 for controlling connection of a data signal line DT to driving transistor 201.

In a light-emitting period, the power source voltage ELVDD may be a voltage of an anode of current light-emitting element 206. A power source voltage ELVSS may be a voltage of a cathode of element 206. A voltage VRES applied to the reset transistor 204 may be an initial voltage for resetting the gate of driving transistor 201 to a predetermined voltage. Transistors of the pixel circuit in FIG. 22 may be formed of p-channel transistors, and operation of the pixel circuit may be controlled by control signals through gate signal lines Scan(n), Scan(n-1), and EM(n). Also, as shown, the pixel circuit in FIG. 22 uses a six transistor-one capacitor (6 Tr-1 Cp) configuration.

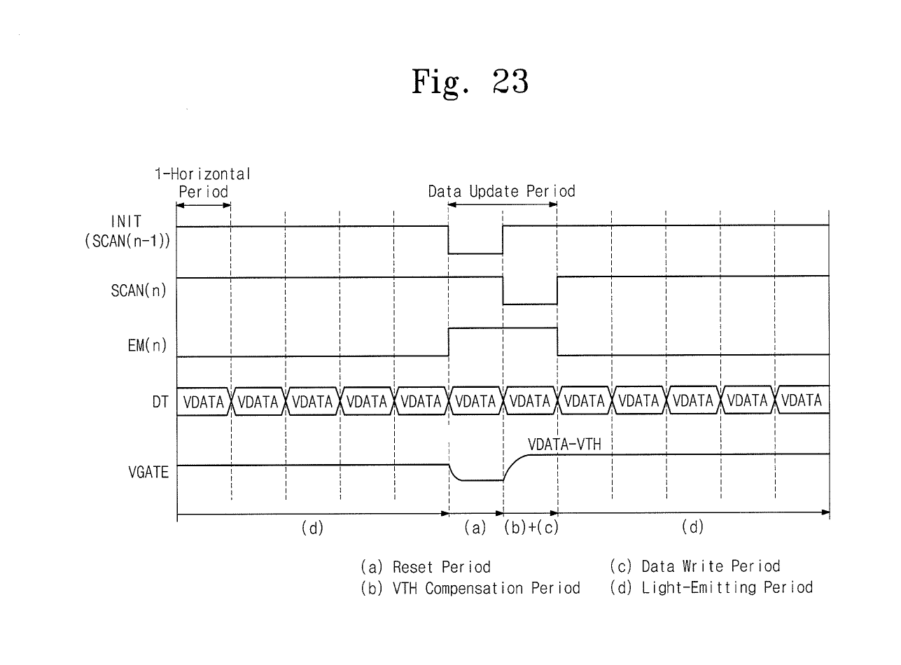

FIG. 23 is a timing diagram describing operation of the pixel circuit in FIG. 22. The timing diagram include period (a) as a reset period. During period (a), a gate voltage of a driving transistor 201 may be reset to a voltage VRES, by applying initial signal INIT at a low level to gate signal line Scan(n-1) to turn on reset transistor 204.

During a period ((b)+(c)), a gate signal line Scan(n) has a low level to turn on switching transistor 202. Also, selection transistor 207 is turned on. Under these conditions, voltage data signal VDATA is applied to the driving transistor 201. At this time, because the gate and drain of driving transistor 201 are diode-connected through switching transistor 202, a voltage obtained by subtracting the threshold voltage of the driving transistor 201 from voltage VDATA of the data signal is applied to the gate of driving transistor 201, as illustrated in equation (1). The gate voltage VGATE of the driving transistor 201 is stored in capacitor 205.

VGATE=VDATA−Vth (1)

Period (d) may be a light-emitting period where switching transistor 202 and selection transistor 207 are turned off, a gate signal line EM(n) has a low level to turn on light-emitting control transistors 203 and 208. Because a voltage across the capacitor 205 is equal to a gate-source voltage Vgs of the driving transistor 201, a current biased by capacitor 205 is provided to light-emitting element 206 based on the power ELVDD passing through driving transistor 201. Because the driving transistor 201 operates in the saturation region, its drain current may be expressed by equation (2).

I=β(Vgs−Vth)² (2)

In equation (2), β is a coefficient determined based on the size of the driving transistor, Vgs indicates the gate-source voltage of the driving transistor, and Vth indicates the threshold voltage of the driving transistor. Because Vgs is equal to ELVDD−(VDATA−Vth)), the current flowing into the light-emitting element may be expressed by equation (3) based on equations (1) and (2).

I=β(ELVDD−VDATA+Vth−Vth)² (3)

As understood from the equation (3), Vth is cancelled out. Thus, the amount of current flowing into the current light-emitting element 206 may be controlled based on the voltage VDATA of the data signal without depending on a variation in the threshold voltage of driving transistor 201. Accordingly, the pixel circuit in FIG. 22 is effectively compensated for a variation in the threshold voltage of driving transistor 201.

However, as illustrated in FIG. 23, if period ((b)+(c)) in the data update period is insufficient, it is impossible to compensate for variation in threshold voltage of the driving transistor. For example, since a time (e.g., a time taken to write VDATA at the driving transistor 201) is shortened in proportion to an increase in the number of pixels in the display, compensation cannot be sufficiently performed and image quality (e.g., display irregularity) may become serious. (The period ((b)+(c)) means that threshold compensation for the driving transistor and a data write operation are performed in the same period, e.g., are simultaneously performed in the same period. Thus, threshold voltage compensation and data write operations are not independent from one another).

Also, when pixel density increases to implement a high-definition display, the area per pixel be scaled down. For this reason, if the number of transistors in each pixel circuit increases, it is impossible to include all the transistors in a predetermined area.

One or more of the following embodiments provide a pixel circuit formed of transistors which compensate for variations in the threshold voltage of the driving transistor and/or controls the drain current flowing into the light-emitting element of each pixel. The transistors may be p-channel, n-channel transistors, or a combination of p-channel and n-channel transistors.

### First Embodiment

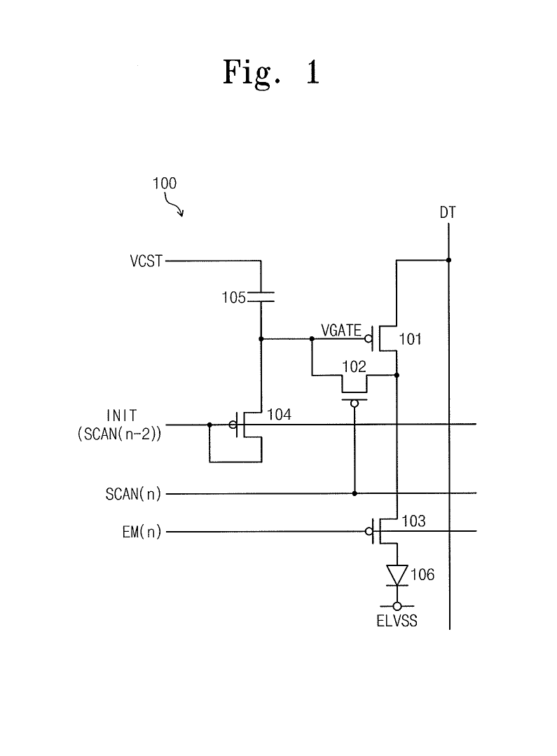

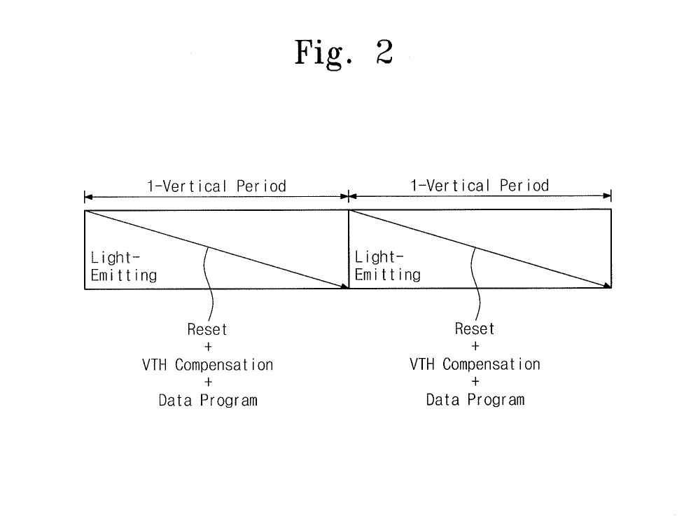

FIG. 1 illustrates a first embodiment of a pixel circuit 100 which includes four p-channel transistors, a capacitive element, and a light-emitting element. The transistors include a driving transistor 101 having a source connected to a data signal line DT, and a gate and drain connected to first transistor 102. A gate of first transistor 102 is coupled to receive a gate signal from Scan line (n) which turns on/off this transistor. The data signal line DT may serve as a signal line and a power line.

The data signal line DT may provide a data signal having a voltage level corresponding to a specific gradation during one period and may provide a power supply voltage ELVDD for causing light-emitting element 106 to provide light during another period. In FIG. 1, the parameter n may indicate a row of pixels.

A second transistor 103 is connected between a drain of driving transistor 101 and a positive electrode of light-emitting element 106. A gate of the second transistor 103 may be connected to gate signal line EM(n), and may be turned on or off by a light-emitting control signal EM. A negative electrode of light-emitting element 106 may be connected to power/potential ELVSS, which is lower than ELVDD. If second transistor 103 is turned on and a high potential of power supply voltage ELVDD is applied to the data signal line DT, drain current according to a gate voltage of driving transistor 101 may be provided to the light-emitting element 106 to cause this element to emit light.

A third transistor 104 may be connected to the gate of driving transistor 101. An initial voltage may be provided to the gate of driving transistor 101 from third transistor 104. A drain and gate of third transistor 104 may be connected, and a signal may be applied to the gate of the third transistor 104 from a gate signal line Scan(n-2). If a low level of an initial signal is provided to the gate signal line Scan(n-2), the third transistor 104 may be turned on. As a result, the initial voltage is applied to the gate of driving transistor 101.

The capacitive element may be capacitor 105. A first end of this capacitor may be connected to the gate of driving transistor 101, and may hold a voltage provided to the gate of the driving transistor 101. A second end of the capacitor is not connected to the gate of driving transistor 101, but rather is connected to a set voltage line VCST for providing a set (or predetermined) voltage.

FIG. 2 illustrates a first embodiment for driving an electro-optic device which includes pixel circuits as shown in FIG. 1. The driving method in FIG. 2 is a progressive driving method, in which a set of initialization, threshold voltage compensation on the driving transistor, and data programming are performed in a line-sequential manner in a 1-vertical period. In the progressive driving method, when a data update operation on a pixel is performed, a pixel not performing data updating may emit a light. For this reason, it is possible to provide a light-emitting period that is relatively long. In exemplary embodiments, light-emitting may be performed during half a period, that is different from a period in which data updating is performed.

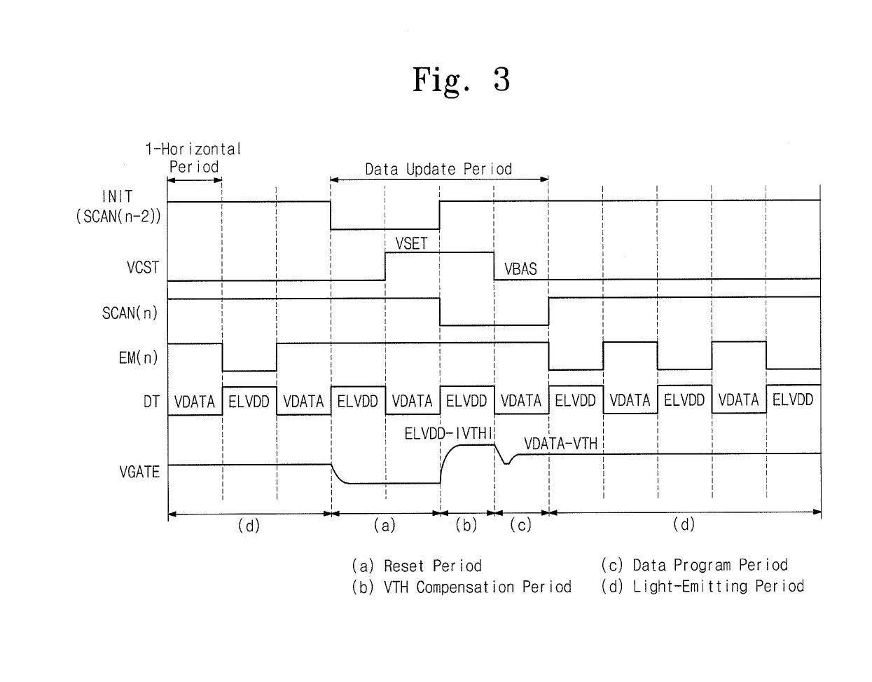

FIG. 3 is an example of a timing diagram which includes a horizontal period in which the progressive driving method is performed for pixel circuit 100. Operation of pixel circuit 100 may be divided into a data update period and a light-emitting period. The data update period may be divided into a reset period (a), a threshold voltage compensation period (b), and a data program period (c). In one embodiment, threshold voltage compensation and data programming may be performed at the same time. In other embodiments, threshold voltage compensation period and the data program period may be independent, separate periods.

If threshold voltage compensation and data programming are performed at the same time, a threshold voltage of the driving transistor may be detected by a data voltage. In such a case, the threshold voltage may be insufficiently compensated according to a level of a data voltage that may arise.

However, as illustrated in FIG. 3, because the threshold voltage compensation period and data program period are separated (e.g., not performed simultaneously in a same period), any voltage to be provided to a driving transistor (other than a data voltage) may be set when the threshold voltage is compensated. Also, when a time other than a data write time is used, it is possible to make the threshold voltage compensation period longer. As a result, compensation of the threshold voltage of the driving transistor may be performed.

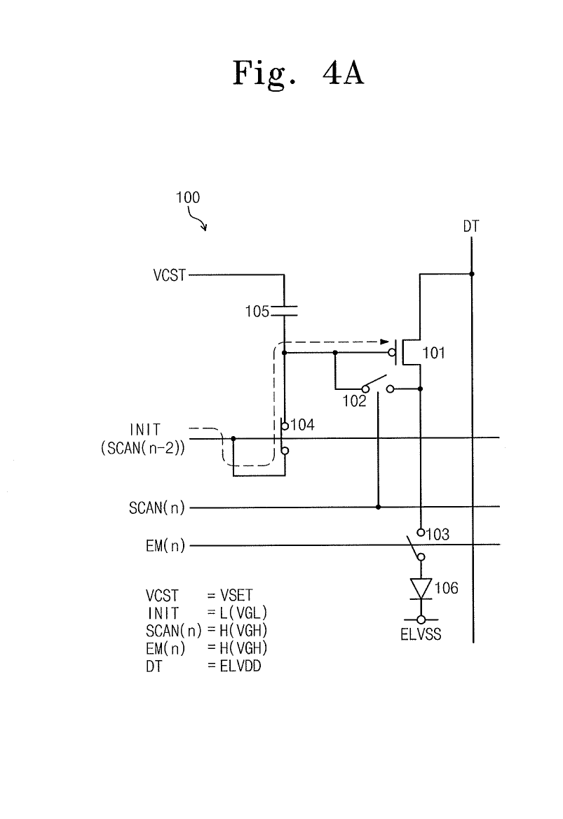

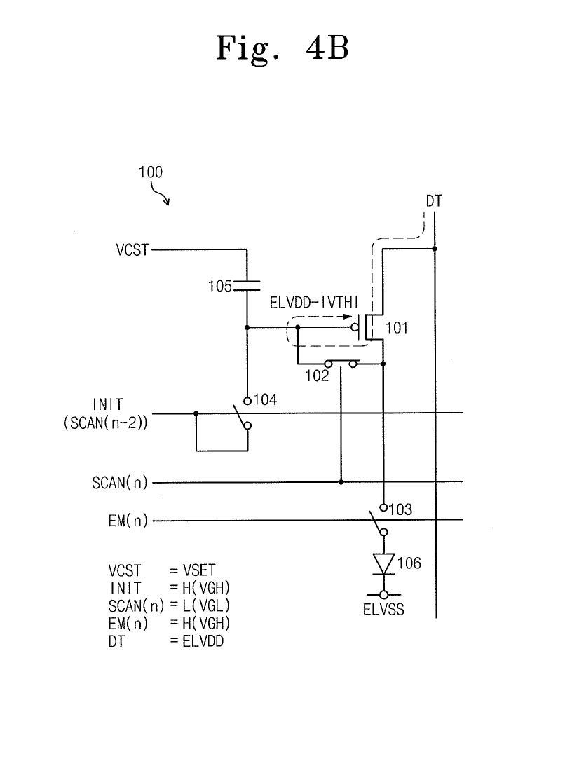

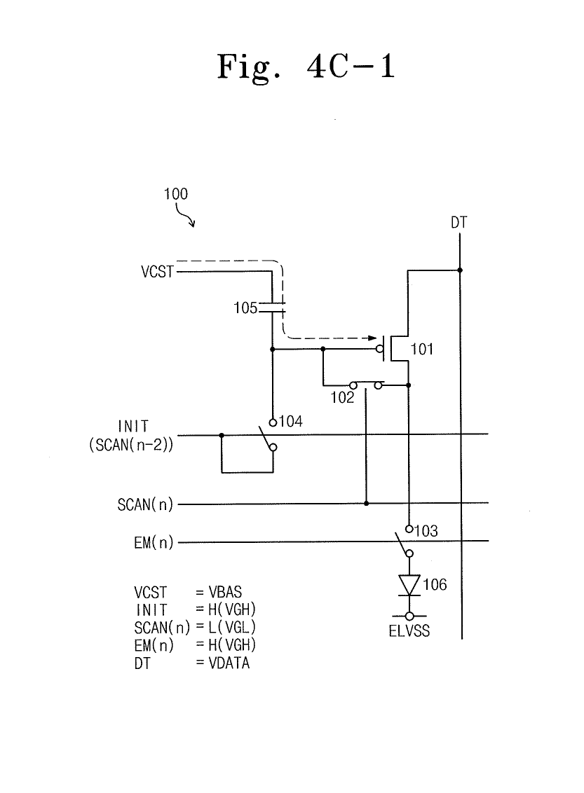

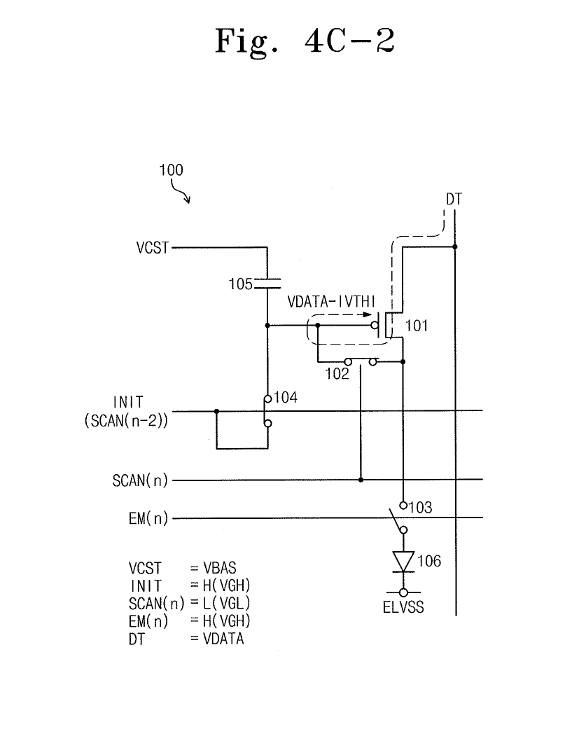

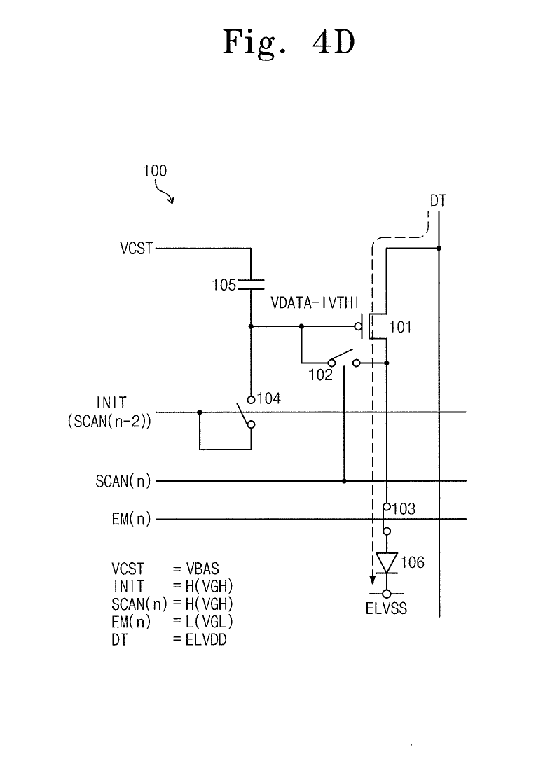

Operation of pixel circuit 100 according to the timing diagram in FIG. 3 is described with reference to FIGS. 4A-4D. FIG. 4A illustrates the state of the pixel circuit 10 during a reset period. During this period, a gate signal line Scan(n) and a gate signal line EM(n) may have a high level, so that first transistor 102 and second transistor 103 are turned off. A signal having a low level gate voltage VGL as an initial voltage is received from gate signal line Scan(n-2).

Also, during the reset period, third transistor 104 may be turned on. At this time, a gate voltage of a driving transistor 101 may be reset to an initial voltage (VGL−|Vth|), where Vth is the threshold voltage of third transistor 104. After the gate signal line Scan(n-2) goes to a low level and a time corresponding to a 1-horizontal period elapses, a set voltage line VCST may transition from a low level VBAS to a high level VSET.

FIG. 4B illustrates a threshold voltage compensation period. During this period, power supply voltage ELVDD is provided to data signal line DT. The power supply voltage ELVDD on this line is then applied to a source of driving transistor 101. As a signal of the gate signal line Scan(n) transitions from a high level to a low level, first transistor 102 may be turned on, to place the drain and gate of driving transistor 101 in a diode-connected state. In this state, a voltage of (ELVDD−|Vth|) may be provided to the gate of driving transistor 101, and capacitor 105 may be charged by the voltage of (ELVDD−|Vth|). Here, Vth is the threshold voltage of driving transistor 101. A threshold voltage, not set forth above, of threshold voltages described at resetting may be a threshold voltage of the driving transistor 101.

FIG. 4C-1 illustrates a data program period. First, the set voltage line VCST connected to capacitor 105 may transition from a high level VSET to low level VBAS. As a result, a potential of the gate of driving transistor 101 may be lowered by (VSET−VBAS). This operation lowers the gate potential of the driving transistor in order to allow a data signal to be written at the gate of the driving transistor. As a voltage of the set voltage line VCST connected to capacitor 105 varies, it is possible to write the data signal with information of the threshold voltage held at the gate of driving transistor 101.

FIG. 4C-2 illustrates the same data program period. A data signal VDATA may be provided to data signal line DT. Because first transistor 102 is turned on, a data voltage of (VDATA−|Vth|) may be provided to the gate of driving transistor 101, and the capacitor 105 may hold the data voltage of (VDATA−|Vth|).

FIG. 4D illustrates a light-emitting period. The power supply voltage ELVDD may be provided to the data signal line DT at this time. At the same time, a low level signal may be applied to the gate signal line EM(n) to turn on the second transistor 103. A drain current according to the gate voltage of the driving transistor 101 may therefore flow into light-emitting element 106, and light-emitting element 106 may emit light corresponding to the drain current. Afterwards, light-emitting and non-light-emitting operations may be iterated every 1-horizontal period.

In view of the foregoing explanation, it is apparent that because the threshold voltage compensation period and data program period are separated and independent from one another, a voltage detected at a time the threshold voltage is detected may be different from the data voltage. Because a voltage provided to data signal line DT varies (e.g., is not the same) during the threshold voltage compensation and data program periods, it is unnecessary to increase the number of transistors of pixel circuit 100. Rather, as illustrated in FIG. 3, it is possible to perform progressive driving using four transistors.

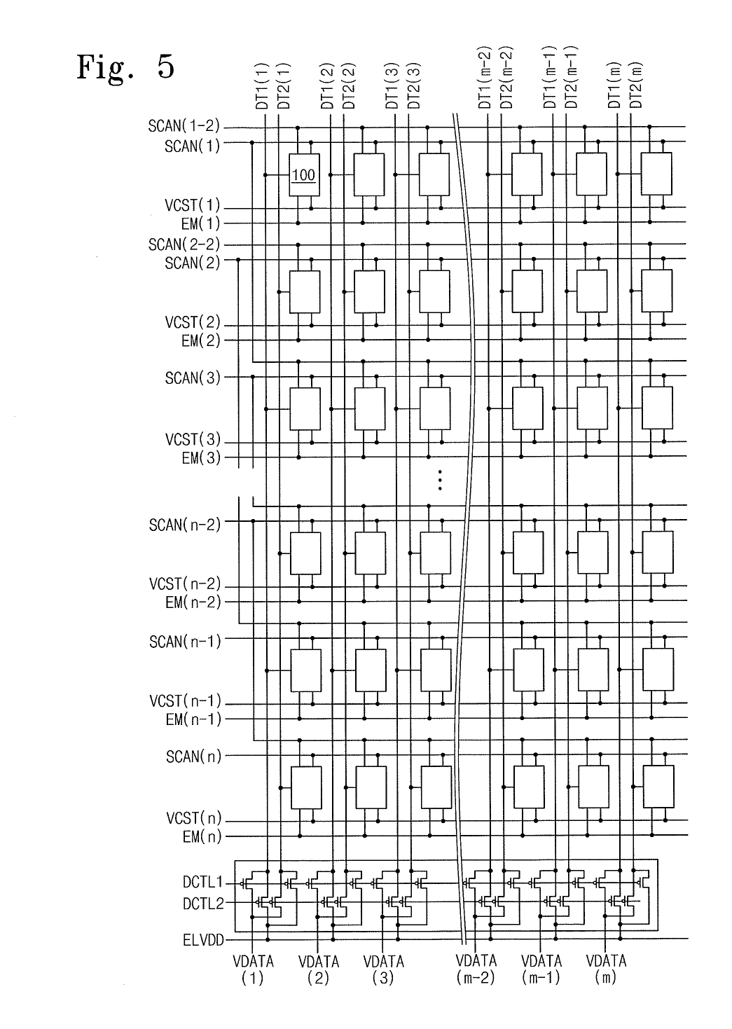

FIG. 5 illustrates a plurality of pixel circuits 100 arranged in a matrix shape of a display panel. As shown, two data signal lines are provided for each column of pixel circuits 100. The first data signal line DT(1) may be connected to pixel circuits in odd-numbered rows. The second data signal DT(2) may be connected to pixel circuits in even-numbered rows. Each data line provides a power supply voltage ELVDD and a data signal VDATA alternately to corresponding pixel circuits. Switching between the power supply voltage ELVDD and data signal VDATA on these lines may be performed, for example, by control signals DCTL1 and DCTL2 using a de-multiplexer circuit. Also, a gate signal line Scan(m-2), a gate signal line Scan(m), a set voltage line VCST, and a gate signal line EM(m) may be connected to each pixel circuit 100, where m=1, 2, . . . , n.

In FIG. 5, pixel circuits 100 are arranged in a matrix shape and a part of a data signal line driving circuit is shown. An electro-optic device including these pixel circuits may additionally, or alternatively, include one or more peripheral circuits such as a gate signal line driving circuit, a data signal line driving circuit, a controller controlling data signals, etc.

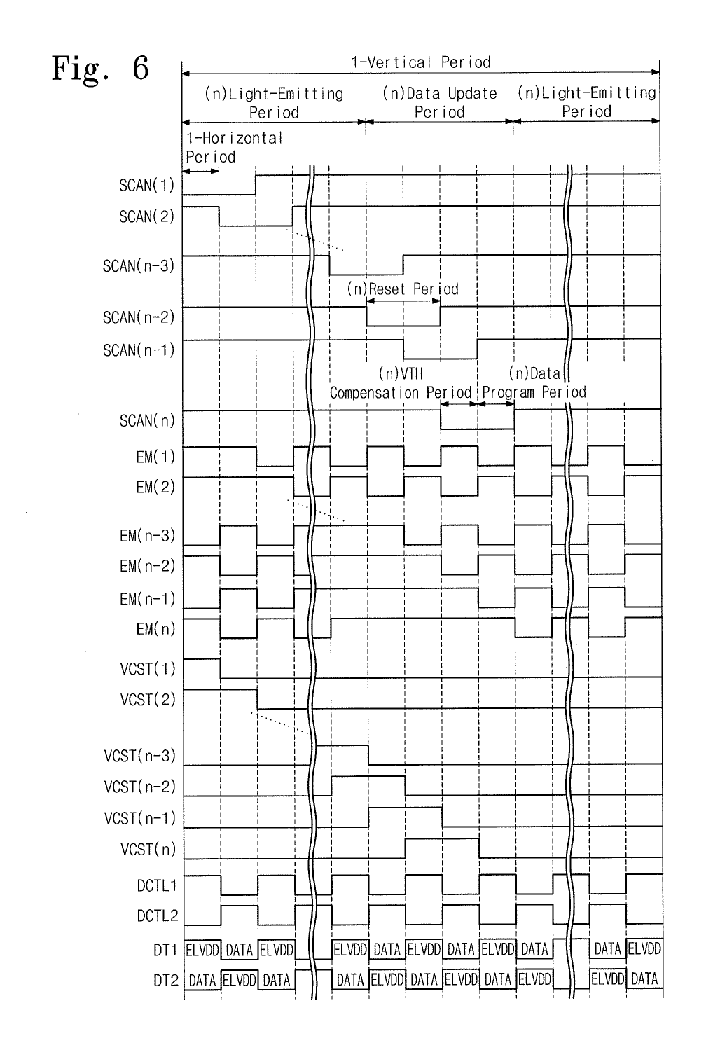

FIG. 6 illustrates an example of a timing diagram of a vertical period. In implementing a progressive driving method, initialization, threshold voltage compensation, data programming, and light-emitting may be sequentially performed every row of pixel circuits. The rows of pixel circuits may be selected by a gate signal line Scan(m-2) and a gate signal line Scan(m). For example, when threshold voltage compensation and data programming are performed for a pixel circuit in one odd-numbered numbered row, initialization on driving transistors may be performed for pixel circuits in a next odd-numbered row. When a data program period perform for one or more pixel circuits in an odd-numbered row ends, a light-emitting period is performed for the one or more pixel circuits based on light-emitting control signal(s) EM. An analogous operation may be performed for pixel circuits in even-numbered rows. Through this process, pixels may gradually emit light within a 1-vertical period.

In the event that the frame frequency is constant, if the number of gate signal lines increases because of the use of a greater number of pixels in the panel, a data write time on pixel circuit 100 may be shortened. However, in accordance with the present embodiment, the threshold voltage for the driving transistor in each pixel circuit may be compensated more accurately, by detecting the threshold voltage at a predetermined constant voltage (e.g., a voltage higher than that of a data signal, for example, a power supply voltage ELVDD).

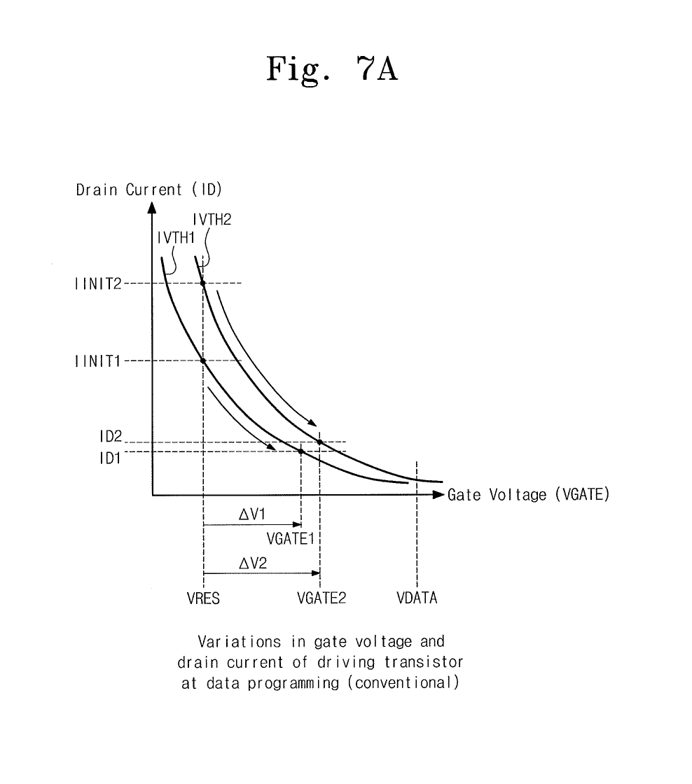

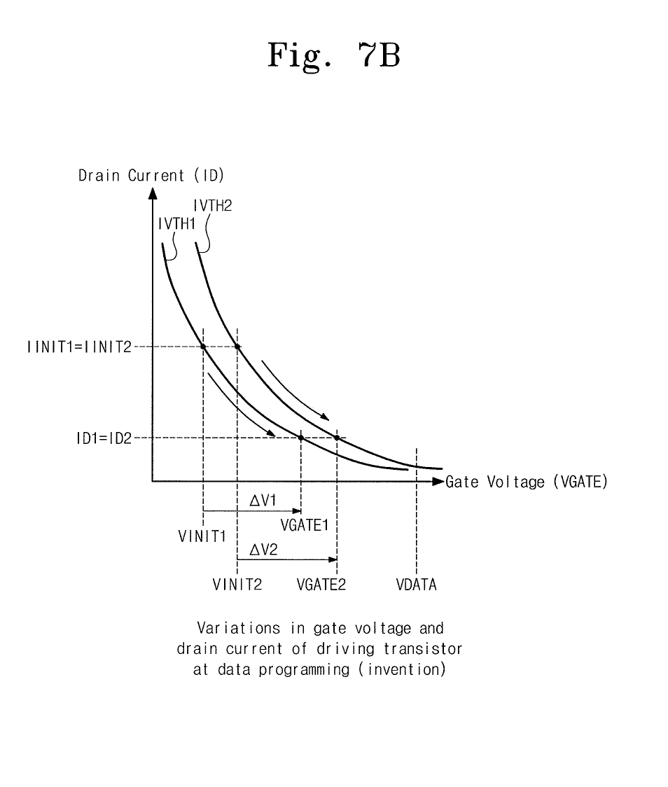

FIGS. 7A and 7B shows relationship between a gate voltage and drain current of a driving transistor during a data programming operation. In FIG. 7A, a relationship between a gate voltage and drain current during data programming according to one type of pixel circuit is shown. In this case, initialization is performed using a constant voltage VRES. Thus, taking two pixels IVTH1 and IVTH2 into consideration having different threshold voltages, the gate voltages are set to the same voltage VRES during initialization. However, drain currents IINIT1 and IINIT2 of pixels IVTH1 and IVTH2 are different as a result of differences in threshold voltages of the driving transistors of these pixels, and/or due to other types of process variation. Thus, threshold voltage compensation and data programming may commence with different drain current values.

Generally, the gate voltage of a driving transistor may be changed up to (VDATA−|Vth|) by threshold voltage compensation and data programming, but only when the amount of time to perform these operations is sufficient. The gate voltage of a driving transistor may not be changed up to (VDATA−|Vth|) when the time required to perform threshold voltage compensation is insufficient. When the data update period is completed, drain current values may be set to ID1 and ID2 for pixels IVTH1 and IVTH2. Therefore, drain currents of these two pixels may be different. This difference may alter the intensity of light emitted from the light-emitting elements in these pixels, to thereby produce irregular display of images.

In FIG. 7B, threshold voltage compensation is performed before the start of data programming. Also, initial voltages are provided to the gates of the driving transistors of the pixels and are subject to change in connection with threshold voltage. As a result, data programming may commence with drain currents IINIT1 and IINIT2 having the same value.

More specifically, a gate voltage may be varied to (VDATA−|Vth|) at a data program period. If the voltage stored in the capacitor and data program time do not vary, variations ΔV1 and ΔV2 of gate voltages may cause the voltages to shift by the same amount. Therefore, drain currents ID1 and ID2 of driving transistors may be equal to each other at completion of data programming. Thus, although threshold voltages of driving transistors of two pixels are different, it is possible to reduce or altogether eliminate display irregularity.

From a comparison of FIGS. 7A and 7B, it is apparent that by separating the threshold voltage compensation and data program periods, the threshold voltage of the driving transistor of each pixel circuit may be detected before performing a data program operation. Also, an initial gate voltage may be determined based on the threshold voltage before the data program operation is performed.

Additionally, compensation for the threshold voltage of the driving transistor of each pixel circuit may not be performed using the data voltage. Also, the threshold voltage of the driving transistor may be detected using a constant voltage (e.g., a power supply voltage ELVDD) different from data voltage. Thus, variation in the threshold voltage of the driving transistor may be detected and compensated more accurately. Also, since the number of transistors for a pixel circuit is reduced (e.g., from 6 such as shown in FIGS. 22 to 4), the first embodiment may be advantageous in implementing a high density display device.

### Second Embodiment

A second embodiment may use the same pixel circuit as FIG. 1, but differs in that a simultaneous driving method is implemented in which initialization, threshold voltage compensation, and light-emitting on all pixels are performed at the same time.

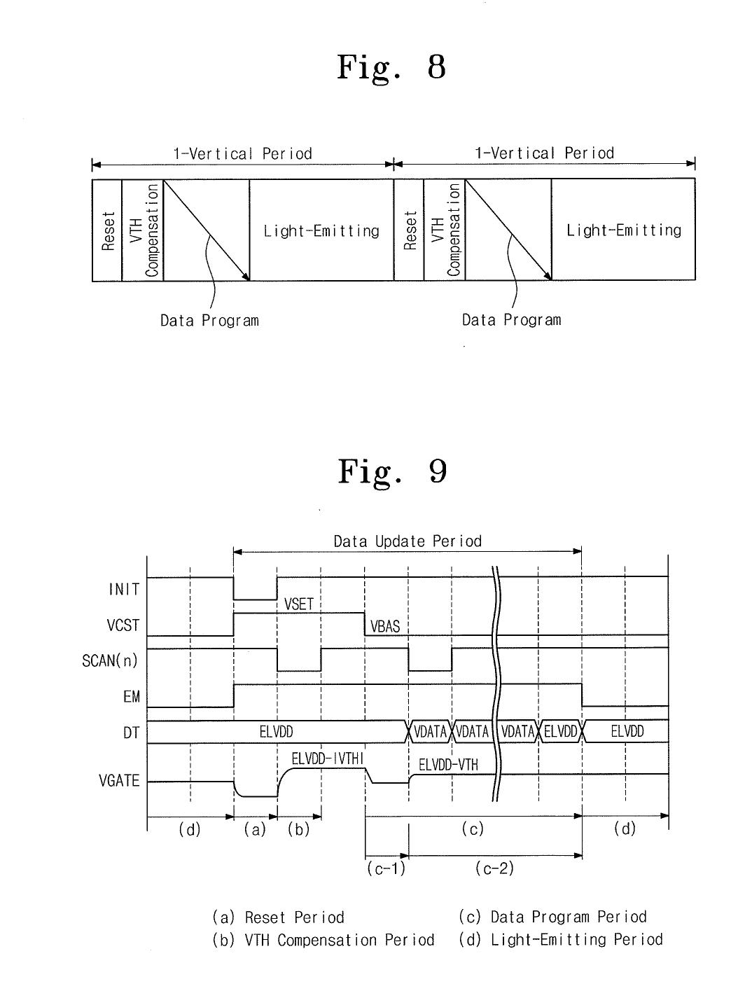

FIG. 8 illustrates operation of pixel circuits using a simultaneous driving method in a vertical period. As illustrated, the simultaneous driving method is a method in which all pixels emit light after initialization, threshold voltage compensation, and data programming is performed for these pixels in a 1-vertical period.

FIG. 9 illustrates an example of a timing diagram of the simultaneous driving method during a horizontal period. As shown, operation of pixel circuit 100 may be divided into a reset period (a), a threshold voltage compensation period (b), a data program period (c), and a light-emitting period (d). In the data program period (c), a power supply voltage ELVDD may be provided to data signal line DT during a period C-1, during which time the voltage of VCST falls from a set voltage VSET to a lower level voltage VBAS. The voltage VCST corresponds to a gate potential of the driving transistor of a pixel circuit. During period C-2, a data signal is provided to the data signal line DT and a data program operation is performed.

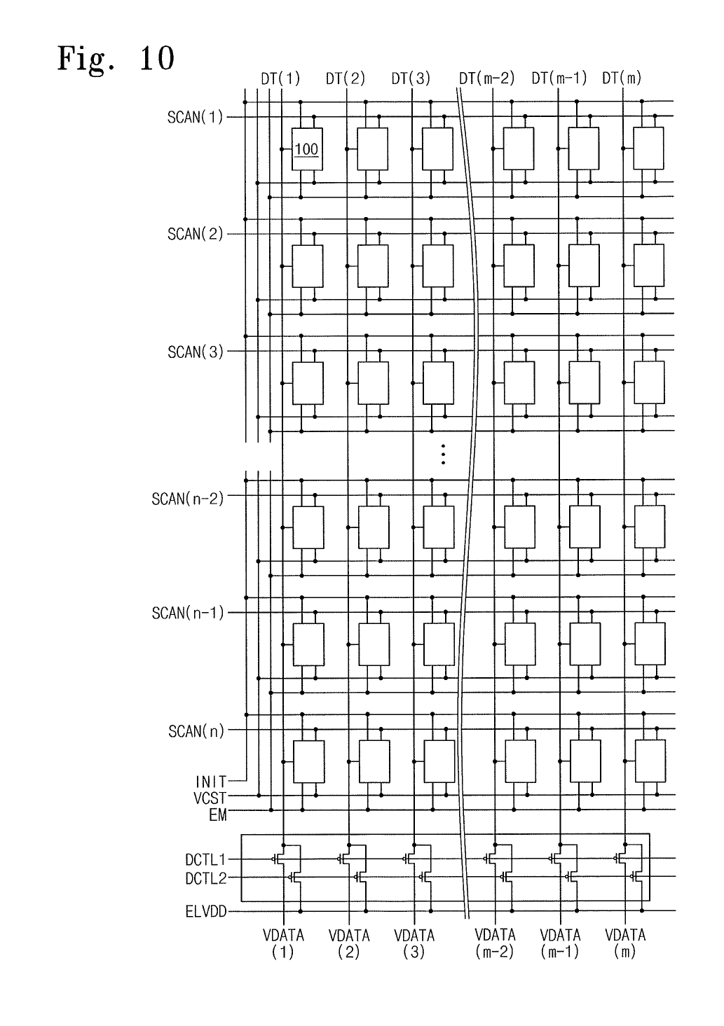

FIG. 10 illustrates a plurality of pixel circuits 100 arranged in a matrix. Unlike the first embodiment, one data signal DT is provided for every pixel column. This is made possible because the threshold voltage compensation period and data program period are separated from one another. Thus, when a simultaneous driving operation is performed using pixel circuits shown in FIG. 1, the number of data signal lines may be reduced. Also, a gate signal line INIT providing an initial voltage, a set voltage line VCST, and a gate signal line EM may be used in common by all pixels. A different gate signal line Scan(n) may be provided for each pixel row.

In FIG. 10, a pixel unit including pixel circuits 100 are illustrated to be arranged in a matrix shape. Part of a data signal line driving circuit is also illustrated. However, an electro-optic device formed according to the second embodiment may include a number of additional peripheral circuits, such as a gate signal line driving circuit, a data signal line driving circuit, a controller controlling data signals, etc.

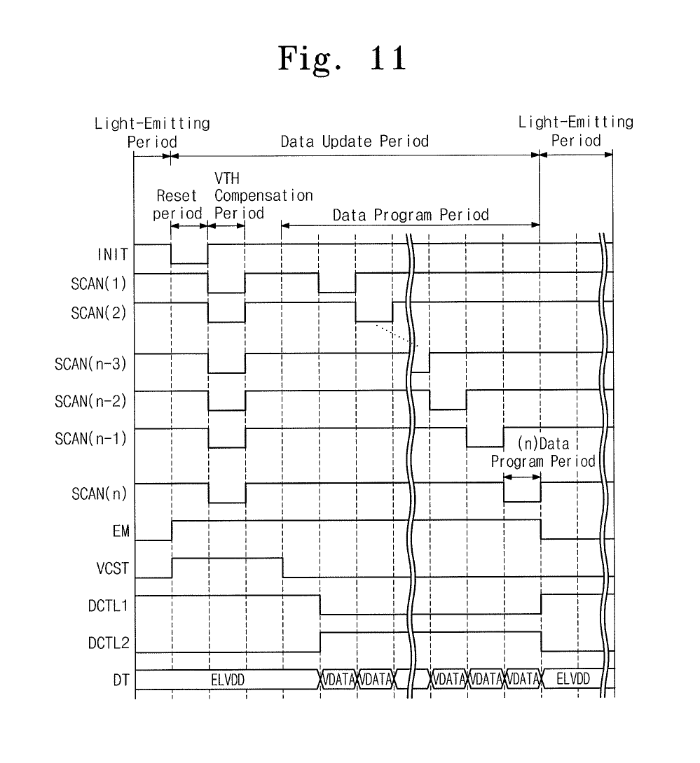

FIG. 11 illustrates an example of a timing diagram in a vertical period of operation of the pixel circuit. As illustrated in FIG. 11, 1-vertical period may be divided into data update and light-emitting periods. The data update period may be divided into a reset period, threshold voltage compensation period, and data program period.

In the reset period of the data update period, a low level of an initial voltage may be simultaneously provided to gate signal lines INIT providing an initial voltage to reset all pixels at the same time. Afterwards, a low level of a selection signal may be provided to each gate signal line Scan(n) at the same timing, and threshold voltages of driving transistor in all pixels may be compensated. At this time, a power supply voltage ELVDD may be provided to a data signal line DT.

Next, a low level of the selection signal may be sequentially provided to the gate signal lines Scan(n), and data may be programmed for the pixel circuits in each row. When the data update period ends, a light-emitting control signal EM may be provided such that all pixels operation in a light-emitting state to thereby emit light according to gate voltages of their respective driving transistors.

Implementing the simultaneous driving method allows the pixel circuits to be simplified in terms of their structure. This is because the gate signal line INIT providing an initial voltage, a set voltage line VCST, and gate signal line EM are common with respect to all pixel circuits. Also, threshold voltage compensation for the driving transistors may not be performed using a data voltage. Also, threshold voltage may be detected using a constant voltage (e.g., a power supply voltage ELVDD) different from the data voltage. Thus, a variation in the threshold voltage of each driving transistor may be detected and compensated more accurately. Also, the number of transistors for implementing each pixel circuit may be reduced (e.g., from 6 to 4), to thereby allow a high density display device to be implemented.

### Third Embodiment

A third embodiment uses a pixel circuit different from the pixel circuit in FIG. 1, and performs progressive driving as described with reference to a first embodiment.

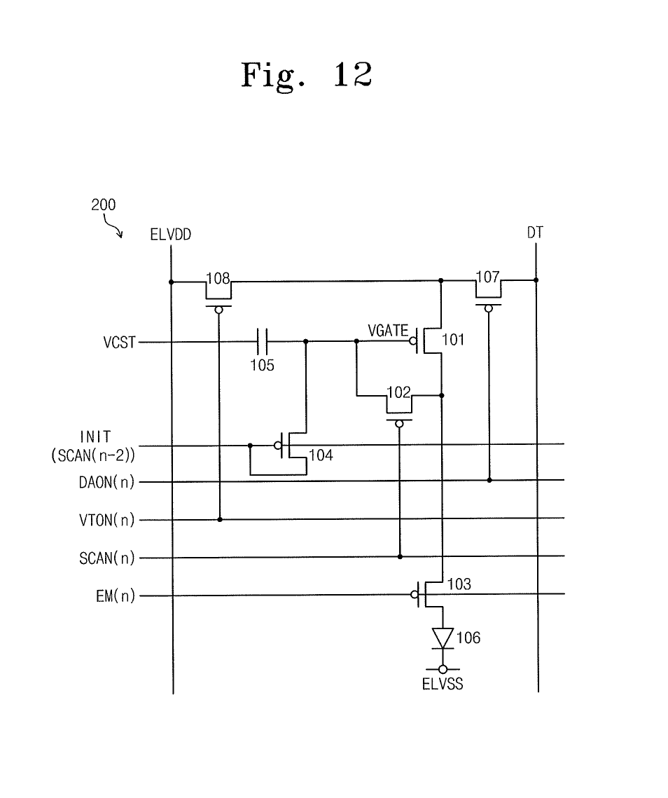

FIG. 12 illustrates the third embodiment of pixel circuit 200. The driving transistor 101, first transistor 102, second transistor 103, third transistor 104, capacitor 105, and light-emitting element 106 may be the same as those in FIG. 1.

Additionally, pixel circuit 200 includes a fourth transistor 107 connected between data signal line DT and the source of driving transistor 101. A gate of the fourth transistor 107 may be connected to a gate signal line DAON(n). Further, a fifth transistor 108 may be connected between a power line supplied with power supply voltage ELVDD and the source of driving transistor 101. A gate of the fifth transistor 108 may be connected to the gate signal line DAON(n).

In the pixel circuit 200, when a predetermined data voltage is provided to the gate of driving transistor 101 and second and fifth transistors 103 and 108 are turned on, light-emitting element 106 emits light. The second transistor 103 and fifth transistor 108 may therefore be viewed as light-emitting control transistors. However, a gate signal line EM(n) for controlling second transistor 103 and a gate signal line VTON(n) for controlling the fifth transistor 108 may provide different timing signals, such that transistors 103 and 108 are separately turned on or off Thus, although a data voltage is provided to the data signal line DT in a light-emitting period, the light-emitting element 106 may emit light based on current from the power line for supplying power supply voltage ELVDD. As a result, light-emitting duty become large.

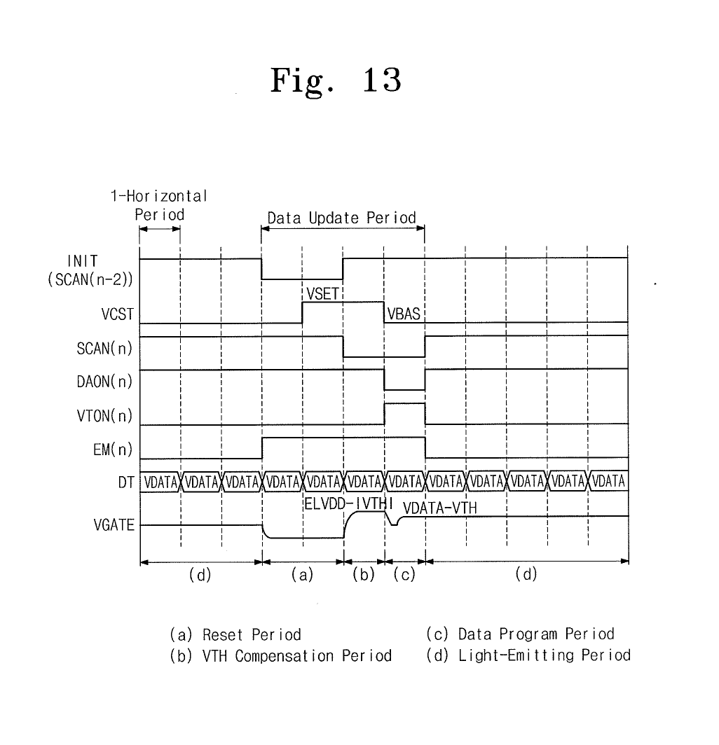

FIG. 13 illustrates an example of a timing diagram showing operation of pixel circuit 200 during a horizontal period. In FIG. 13, a data update period may be divided into a reset period (a), a threshold voltage compensation period (b), and a data program period (c). The reset period may be the same as in first embodiment.

In the threshold voltage compensation period, a low level signal may be provided to gate signal line VTON(n) to turn on a fifth transistor 108, so that power supply voltage ELVDD is applied to driving transistor 101. Meanwhile, in the data program period, fifth transistor 108 may be turned off, so that a low level signal may be provided to gate signal line DAON(n) to turn on fourth transistor 107. At this time, a data signal may be provided to driving transistor 101 from data signal line DT.

As described above, by separating data signal line DT and the power line providing power supply voltage ELVDD, transistors for controlling them may be used as in the first embodiment. Also, the threshold voltage compensation period and the data program period may be separated. Thus, the 1 threshold voltage of the driving transistor may be detected before a data program operation is performed. Also, an initial gate voltage may be determined according to the threshold voltage before the data program operation. Threshold voltage compensation for the driving transistor may therefore be performed using a voltage different in level from a voltage of a data signal.

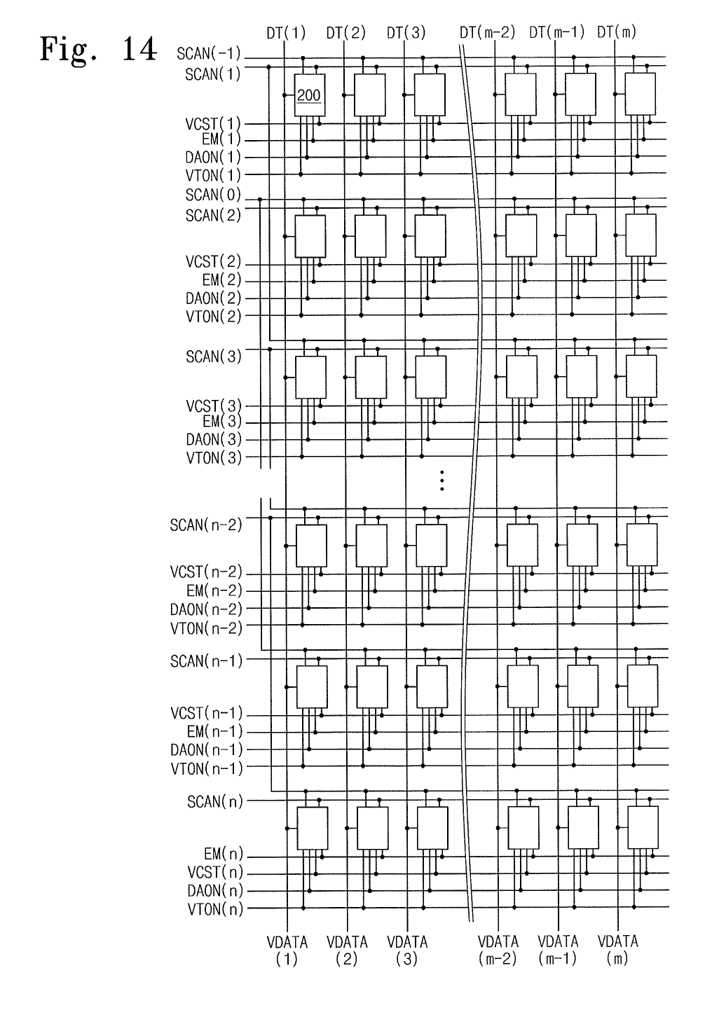

FIG. 14 illustrates a plurality of pixel circuits 200 arranged in a matrix. In FIG. 14, a power line for providing a constant power supply voltage ELVDD in common to all pixels may be omitted, and one data signal line DT may be provided every pixel column. Also, a data signal line DAON(n) and a data signal line VTON(n) may be added with respect to each row of pixel circuits 200.

In FIG. 14, pixel circuits 200 are arranged in a matrix, and a part of a data signal line driving circuit is shown. However, an electro-optic device according to the third embodiment may include one or more peripheral circuits such as a gate signal line driving circuit, a data signal line driving circuit, a controller for controlling data signals, etc.

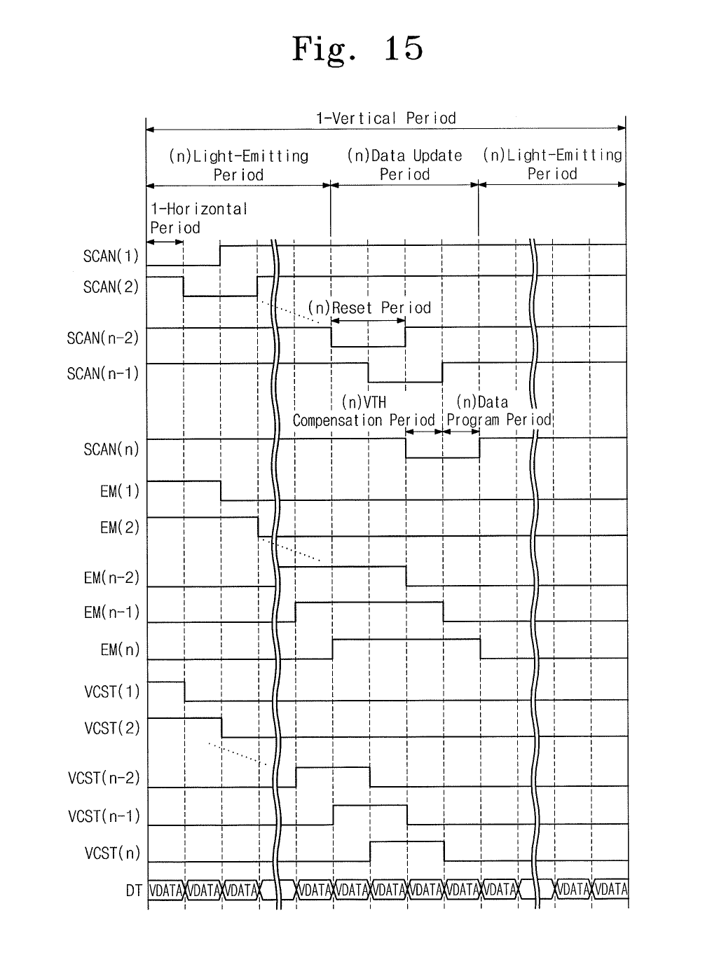

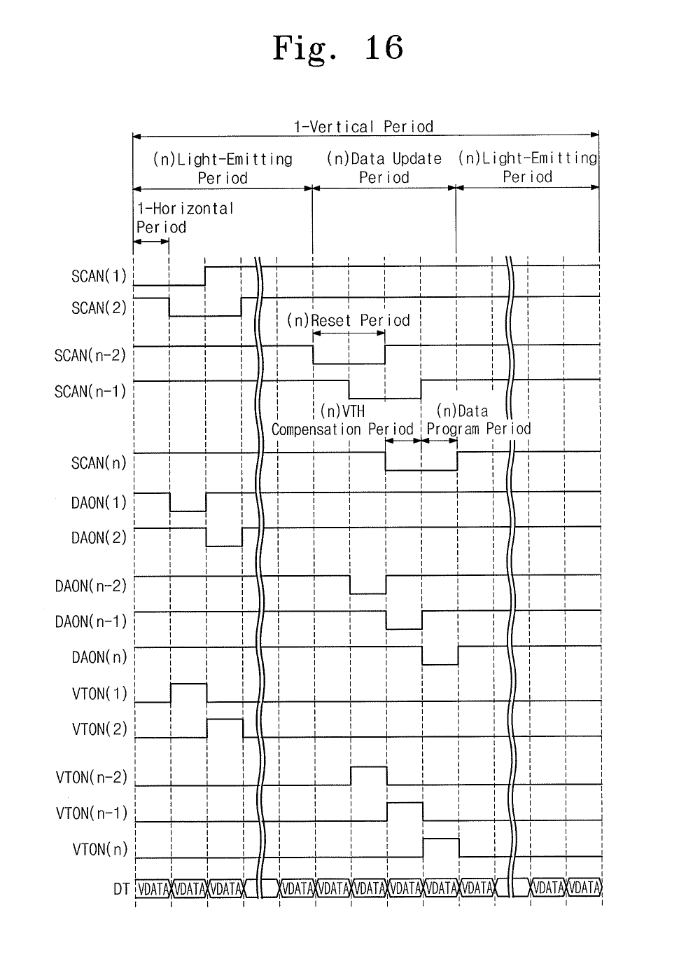

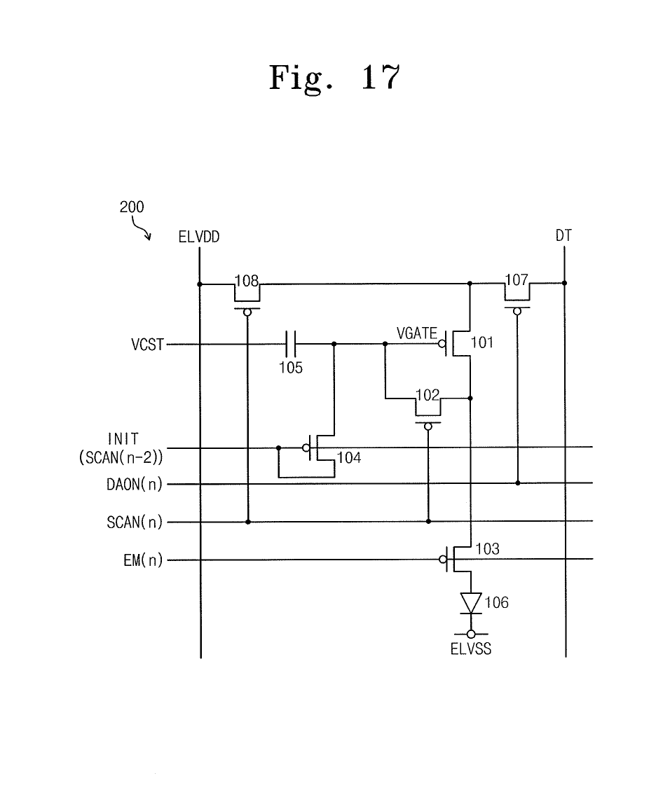

FIGS. 15 and 16 illustrate a timing diagram of a 1-vertical period in accordance with the third embodiment. In a progressive driving method, initialization, threshold voltage compensation, data programming, and light-emitting may be sequentially performed every row of pixel circuits selected by a gate signal line Scan(n-2) and a gate signal line Scan(n). For example, when threshold voltage compensation and data programming are performed at an odd-numbered row, initialization on driving transistors may be performed for a next odd-numbered row. If a data signal is always provided to a data signal line DT and writing of the data signal on an odd-numbered row is performed by a data signal DAON, a data program operation may be ended and a light-emitting period may be performed in which the light-emitting elements emit light according to light-emitting control signal EM. An analogous operation may be performed even-numbered rows, and pixels may gradually emit light within a 1-vertical period.

In this embodiment, because the data signal line and power line are separated, any period other than the data update period may be used as a light-emitting period. Thus, it is possible to make a duty ratio of light-emitting large within a 1-vertical period. In this case, a peak current provided to a light-emitting element may be lowered, so that deterioration of the light-emitting element is reduced. As a result, it is possible to extend the operational lifetime of the light-emitting element.

### Fourth Embodiment

A fourth embodiment corresponds to a simultaneous driving method using a modified version of the pixel circuit in FIG. 12.

FIG. 17 illustrates the fourth embodiment of a pixel circuit 300 which includes driving transistor 101, first transistor 102, third transistor 104, fourth transistor 107, capacitor 105, and a light-emitting element 106 as in FIG. 12. In FIG. 17, fifth transistor 108 is connected between a power line providing power supply voltage ELVDD and driving transistor 101. A gate of fifth transistor 108 is connected to receive a gate signal line EM(n). That is, fifth transistor 108 and second transistor 102 are connected to the same gate signal line EM(n) and are turned on or off at the same timing.

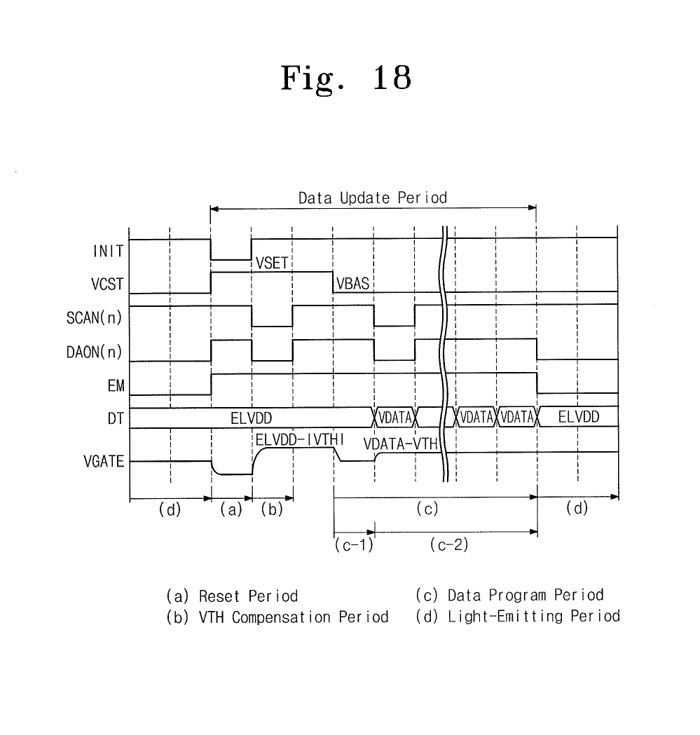

FIG. 18 illustrates a timing diagram for operating pixel circuit 300 during a horizontal period when a simultaneous driving method is performed. A power line ELVDD and data signal line DT of pixel circuit 300 are separated. Also, power supply voltage ELVDD is provided to data signal line DT in a threshold voltage compensation period.

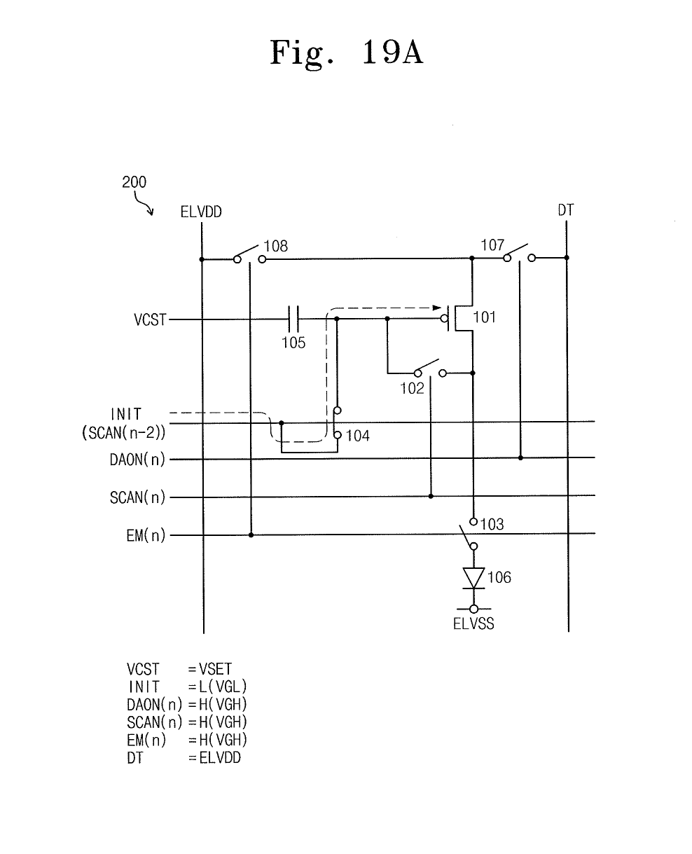

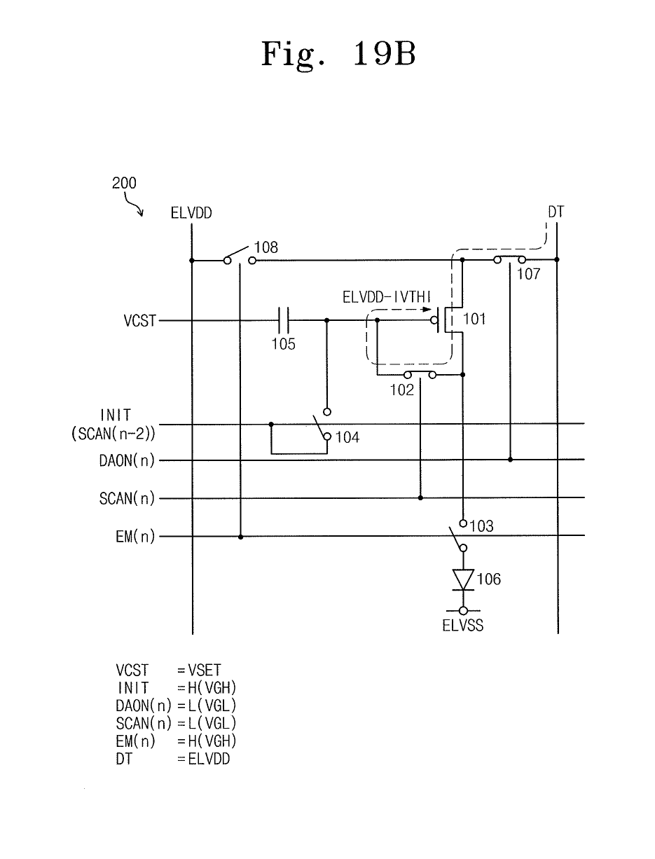

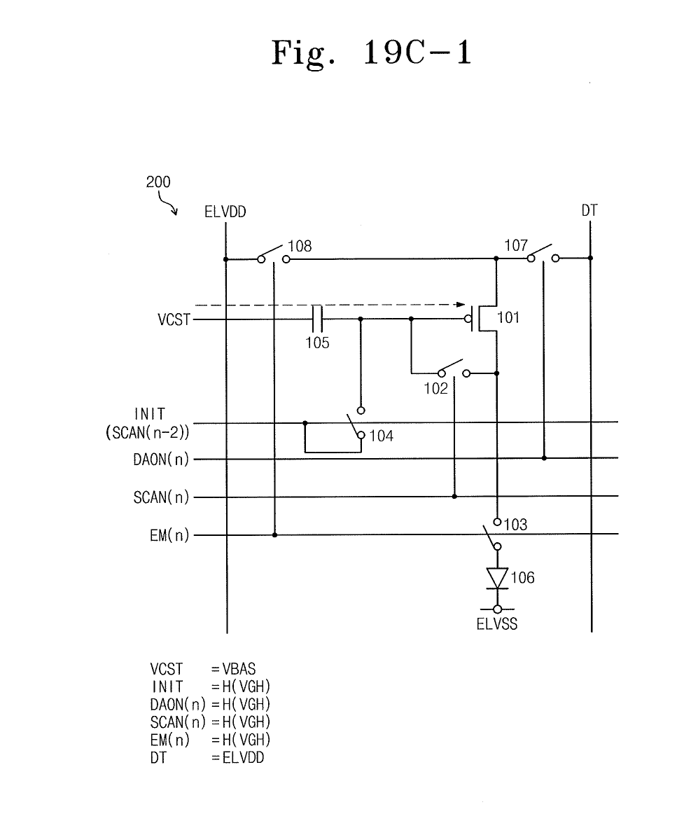

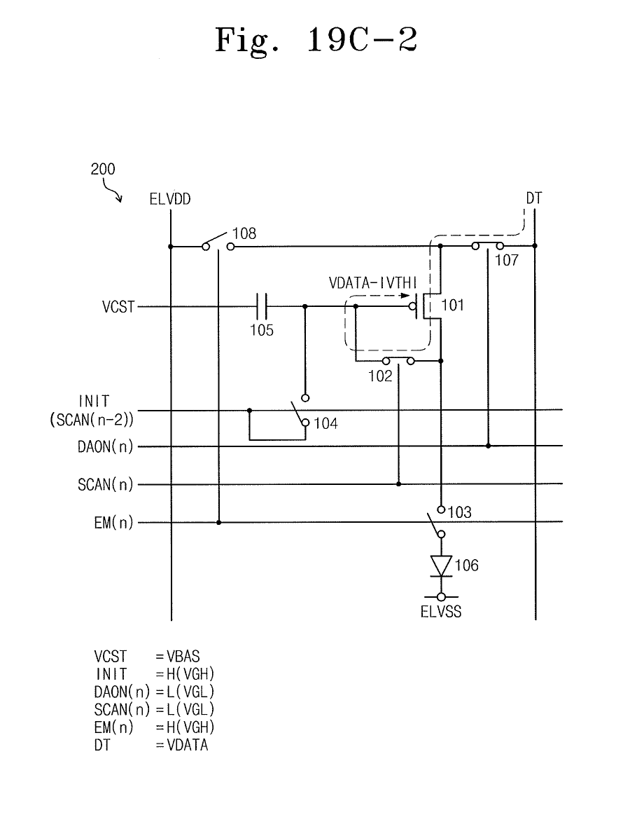

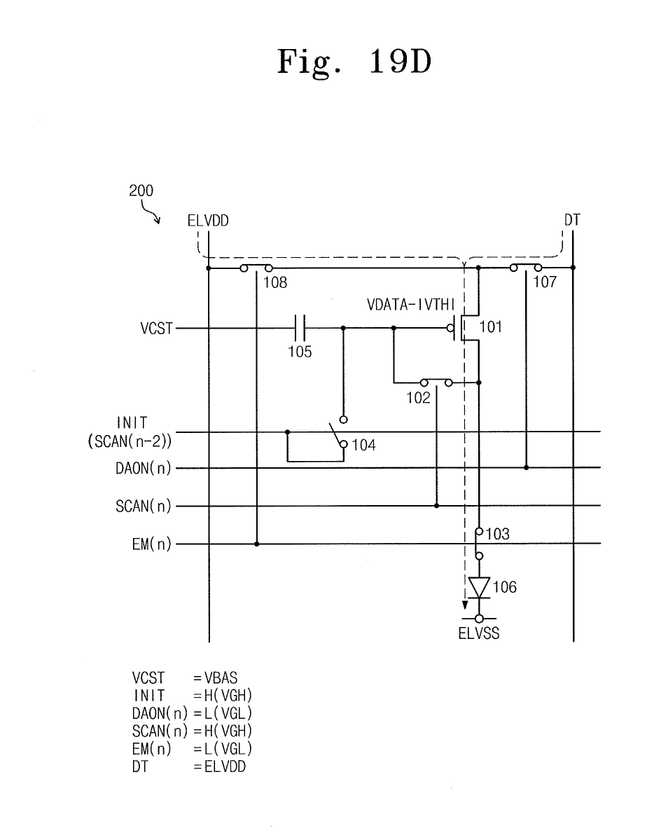

FIG. 19 describes states of pixel circuit 300 during a reset period, threshold voltage compensation period, data program period, and light-emitting period, when pixel circuit 300 is controlled according to the timing diagram in FIG. 18.

FIG. 19A illustrates the state of the pixel circuit during the reset period. In this period, the gate signal line Scan(n), gate signal line DAON(n), and gate signal line EM(n) have a high level, to turn off first transistor 102 and second transistor 103. A signal having a low level VGL, as an initial voltage, is received from gate signal line Scan(n-2) while transistor 104 is turned on. At this time, the gate voltage of driving transistor 101 is reset to an initial voltage (VGL−|Vth|), where Vth is a threshold voltage of third transistor 104. Also, a set voltage line VCST may transition from a low level VBAS to a high level VSET in synchronization with gate signal line Scan(n-2).

FIG. 19B illustrates a state of pixel circuit 300 during the threshold voltage compensation period. In FIG. 19B, a power supply voltage ELVDD is provided to data signal line DT, and first transistor 102 and fourth transistor 107 are turned on by gate signal line Scan(n) and gate signal line DAON(n), which have a low level. As a result, power supply voltage ELVDD may be applied to driving transistor 101, the source of which is connected to data signal line DT. As a result, a voltage of (ELVDD−|Vth|) may be provided to the gate of driving transistor 101, and capacitor 105 may be charged by the voltage of (ELVDD−|Vth|). Here, Vth corresponds to the threshold voltage of driving transistor 101.

FIG. 19C-1 illustrates the state of pixel circuit 300 during the data program period. First, the set voltage line VCST connected to capacitor 105 transitions from high level VSET to low level VBAS. As a result, a potential of the gate of the driving transistor 101 may be lowered by (VSET−VBAS). The gate potential of the driving transistor may be lowered in order to write a data signal at the gate of the driving transistor.

FIG. 19C-2 illustrates the state of pixel circuit 300 during the same data program period. During this period, a data signal VDATA is provided to data signal line DT, and first transistor 102 and fourth transistor 107 are turned on by gate signal line Scan(n) and gate signal line DAON(n), which have a low level. A data voltage of (VDATA−|Vth|) may be provided to the gate of driving transistor 101, and the capacitor 105 may hold the data voltage of (VDATA−|Vth|).

FIG. 19D illustrates the state of pixel circuit 300 during the light-emitting period. In this period, a low level signal may be applied to gate signal line EM(n), to turn on second transistor 103 and fifth transistor 108. At this time, the power supply voltage ELVDD may be applied to data signal line DT, and fourth transistor 107 may be turned on by gate signal line DAON(n), which has a low level. The power supply voltage ELVDD may be applied to light-emitting element 106 from data signal line DT.

As described above, as power supply voltage ELVDD is supplied from a power line and data signal line DT, resistance of a line for providing the power supply voltage ELVDD may be reduced. As a result, a voltage drop generated by current flowing into the light-emitting element may be reduced.

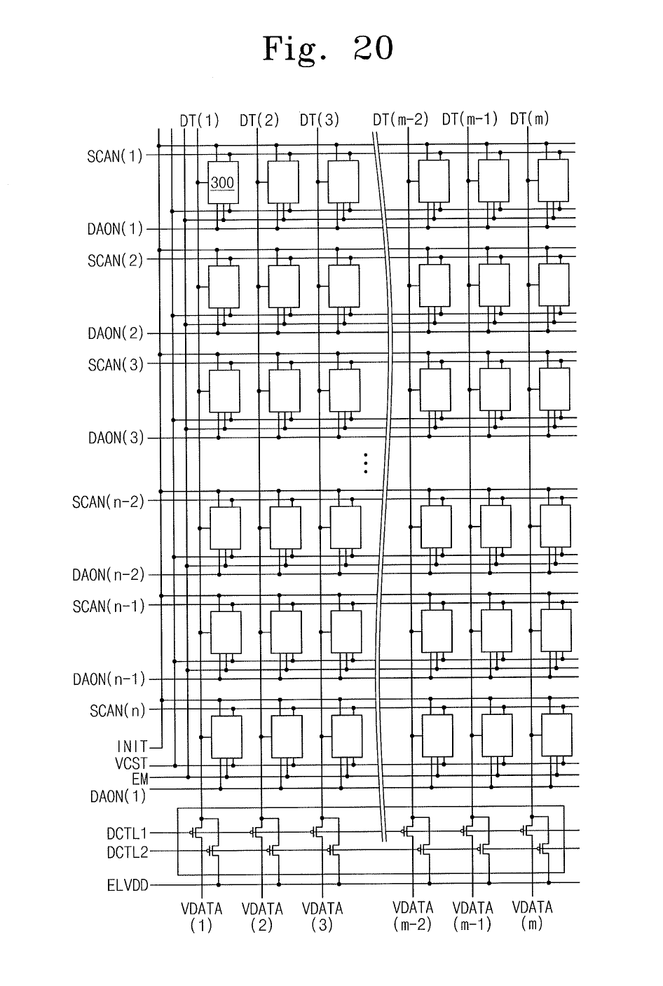

FIG. 20 illustrates pixel circuits 300 arranged in a matrix. In simultaneous driving, a data update period and light-emitting period may be separated. A data signal line DT may be provided for each pixel column. Also, a gate signal line INIT providing an initial voltage, a set voltage line VCST, and a gate signal line EM may be used in common by all the pixel circuits. A gate signal line Scan(n) may be provided to correspond to each pixel row. Also, a power line for providing a constant power supply voltage ELVDD to all the pixel circuits in common may be omitted.

Also, in FIG. 20, a part of a data signal line driving circuit is shown. In addition to this feature, an electro-optic device including pixel circuits 300 may include one or more additional peripheral circuits such as a gate signal line driving circuit, a data signal line driving circuit, a controller controlling data signals, etc.

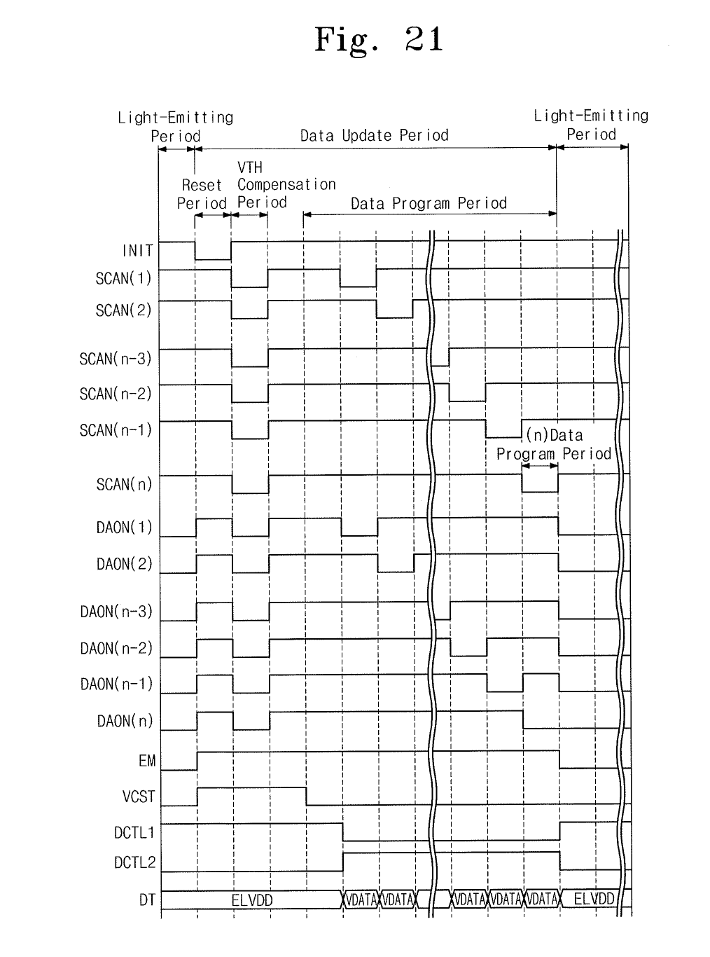

FIG. 21 illustrates a timing diagram for pixel circuit 300 during a 1-vertical period. The 1-vertical period may be divided into a data update period and a light-emitting period. The data update period may be divided into a reset period, a threshold voltage compensation period, and a data program period.

In the reset period of the data update period, a low level initial voltage may be simultaneously provided to gate signal lines INIT, which provide an initial voltage to reset all pixels at the same time. Next, a low level selection signal may be provided to each gate signal line Scan(n) at the same timing, and threshold voltages of the driving transistors in all the pixel circuits may be compensated.

At this time, power supply voltage ELVDD may be provided to data signal line DT. Next, a low level selection signal may be sequentially provided to the gate signal lines Scan(n), and data may be programmed in the pixel circuits in each row. When the data update period ends, a light-emitting control signal EM may be provided to place all the pixel circuit in the light-emitting state, so all the pixels emit light according to gate voltages of driving transistors 101.

As described above, as a power supply voltage ELVDD is supplied from a power line and data signal line DT, resistance of the power line may be reduced, a luminance difference of a display panel may be reduced, and display uniformity may be remarkably improved.

Also, when a simultaneous driving method is implemented, the structure of the driving circuit may be simplified because gate signal line INIT providing an initial voltage, set voltage line VCST, and gate signal line EM are used in common by all the pixel circuits. Also, a frame of the display panel may be narrowed.

Also, detection of and compensation for variations in the threshold voltage of the driving transistors may be performed more accurately because compensation for the threshold voltages of the driving transistors is not performed based on a data voltage, and because a threshold voltage is detected using a constant voltage (e.g., power supply voltage ELVDD) different from the data voltage. Moreover, the pixel circuit of one or more embodiments described herein may use perform threshold voltage compensation with relatively fewer transistors.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method of driving at least one pixel circuit of an electro-optic device, comprising:
performing a reset operation including connecting a first transistor to a gate of a driving transistor that is turned on and an initial voltage to reset a gate voltage of the driving transistor, the initial voltage at a level lower than a voltage of a data signal to be provided to the gate of the driving transistor;
performing a threshold voltage compensation operation including connecting a drain and the gate of the driving transistor when a second transistor connected between the drain and gate of the driving transistor is turned on, applying a first voltage to a data signal line connected to a source of the driving transistor, supplying a second voltage to the gate of the driving transistor, the second voltage varied from the first voltage by a threshold voltage of the driving transistor, the gate voltage of the driving transistor changing from the initial voltage to the second voltage, and holding the second voltage of the driving transistor in a capacitive element having a first terminal connected to the gate of the driving transistor;
performing a data program operation including providing a set voltage at a low level to a second terminal of the capacitive element, providing a data voltage to the data signal line based on a gate potential of the driving transistor that is lower than a potential of the data signal, providing a third voltage to the gate of the driving transistor, the third voltage varied from the data voltage by the threshold voltage of the driving transistor, and holding the third voltage in the capacitive element; and
performing a light-emitting operation including providing the first voltage to the data signal line and providing a drain current according to the third voltage corresponding to the gate voltage of the driving transistor to a light-emitting element, the drain current provided by turning on a light-emitting control transistor connected between the drain of the driving transistor and a positive electrode of the light-emitting element.

2. The method as claimed in claim 1, wherein the first voltage is a power supply voltage of a positive electrode side of the light-emitting element.

3. A method of driving at least one pixel circuit of an electro-optic device, the method comprising:
performing a reset operation including turning on a first transistor connected to a gate of a driving transistor of a pixel circuit and providing an initial voltage lower than a voltage of a first data signal to the gate of the driving transistor to reset a gate voltage of the driving transistor;
performing a threshold voltage compensation operation including connecting a drain and the gate of the driving transistor by turning on a second transistor connected between the drain and the gate of the driving transistor, applying a first voltage to a data signal line connected to a source of the driving transistor, providing a second voltage to the gate of the driving transistor, the second voltage varied from the first voltage by a threshold voltage of the driving transistor, and holding the second voltage of the driving transistor in a capacitive element having a first terminal connected to the gate of the driving transistor; and
performing a data program operation including providing a set voltage at a low level a second terminal of the capacitive element, providing a data voltage to the data signal line based on a gate potential of the driving transistor that is lower than a potential of the first data signal, providing a third voltage to the gate of the driving transistor, the third voltage varied from the data voltage by the threshold voltage of the driving transistor, and holding the third voltage in the capacitive element,
wherein after the reset operation, threshold voltage compensation operation, and data program operation are performed for a plurality of pixel circuits, the method includes:
providing the first voltage to the data signal line, and
providing a drain current to a light-emitting element, the drain current based on the third voltage being the gate voltage of the driving transistor, the drain current provided to the light-emitting element by turning on a light-emitting control transistor connected between the drain of the driving transistor and a positive electrode of the light-emitting element, wherein the light-emitting elements of the pixel circuits emit light at substantially a same time.

4. The method as claimed in claim 3, wherein the first voltage is a power supply voltage of a positive electrode side of the light-emitting element.

5. A method of driving at least one pixel circuit of an electro-optic device, the method comprising:
performing a reset operation including turning on a first transistor connected to a gate of a driving transistor and providing an initial voltage at a level lower than a voltage of a data signal to the gate of the driving transistor to reset a gate voltage of the driving transistor;
performing a threshold voltage compensation operation including connecting a drain and the gate of the driving transistor by turning on a second transistor connected between the drain and the gate of the driving transistor, applying a first voltage to a source of the driving transistor from a power line by turning on a third transistor connected between the source of the driving transistor and a power line supplied with a power supply voltage, providing a second voltage to the gate of the driving transistor, the second voltage varied from the first voltage by a threshold voltage of the driving transistor, the gate voltage of the driving transistor changing from the initial voltage to the second voltage, and holding the second voltage of the driving transistor in a capacitive element having a first terminal connected to the gate of the driving transistor;
performing a data program operation including providing a set voltage at a low level to a second terminal of the capacitive element, setting a gate potential of the driving transistor to be lower than a potential of the data signal, providing a third voltage to the gate of the driving transistor, the third voltage varied from the data voltage by the threshold voltage of the driving transistor, the third voltage provided by turning on a fourth transistor connected between the source of the driving transistor and a data signal line, and holding the third voltage in the capacitive element; and
performing a light-emitting operation including providing the first voltage to the driving transistor from the power line, the first voltage provided by turning on the third transistor and a drain current, the third voltage corresponding to the gate voltage of the driving transistor, and turning on a current light-emitting element by turning on a light-emitting control transistor connected between the drain of the driving transistor and a positive electrode of the light-emitting element.

6. A method of driving at least one pixel circuit of an electro-optic device, the method comprising:
performing a reset operation including turning on a first transistor connected to a gate of a driving transistor of the pixel circuit and providing an initial voltage to the gate of the driving transistor to reset a gate voltage of the driving transistor, the initial voltage at a level lower than a voltage of a first data signal;
performing a threshold voltage compensation operation including connecting a drain and the gate of the driving transistor by turning on a second transistor connected between the drain and the gate of the driving transistor, applying a first voltage to a source of the driving transistor from a power line by turning on a third transistor connected between the source of the driving transistor and the power line, the power line supplied with a power supply voltage, providing a second voltage to the gate of the driving transistor, the second voltage varied from the first voltage by a threshold voltage of the driving transistor, the gate voltage of the driving transistor changing from the initial voltage to the second voltage, and holding the second voltage of the driving transistor in a capacitive element having a first terminal connected to the gate of the driving transistor; and
performing a data program operation including providing a set voltage at a low level to a second terminal of the capacitive element, setting a gate potential of the driving transistor to be lower than a potential of the first data signal, providing a third voltage to the gate of the driving transistor, the third voltage varied from the data voltage by the threshold voltage of the driving transistor, the third voltage provided by turning on a fourth transistor connected between the source of the driving transistor and a data signal line, and holding the third voltage in the capacitive element,
wherein after the reset operation, threshold voltage compensation operation, and data program operation are performed for a plurality of pixel circuits, the method includes:
providing the first voltage to the driving transistor from the power line by turning on the third transistor of each of the plurality of pixel circuits, and
providing drain current to the light-emitting elements of the pixel circuits based on the third voltage being the gate voltage of the driving transistor, the drain current provided by turning on a light-emitting control transistor connected between the drain of the driving transistor and a positive electrode of a light-emitting element in each pixel circuit, wherein the current light-emitting elements of the plurality of pixel circuits emit light at substantially a same time.

7. An electro-optic device, comprising:
a driving transistor having a source connected to a data line and a gate connected to receive a data signal during a program operation, the data signal provided from the data line and corresponding to gradation value, the gate of the driving transistor receiving the data signal while the driving transistor is diode-connected; and
a light-emitting element connected to the driving transistor and supplied with a drain current based on a gate voltage of the driving transistor, wherein an initial value of the gate voltage is determined based on a detected threshold voltage of the driving transistor, and wherein the initial value of the gate voltage is determined and the threshold voltage of the driving transistor is detected before a data program operation is performed.

8. The electro-optic device as claimed in claim 7, wherein:
the threshold voltage of the driving transistor is detected based on a power supply voltage applied to a positive electrode side of the light-emitting element, the electro-optic device further comprising:
a capacitive element having a first electrode to receive a set voltage during the data program operation and a second electrode connected to the gate of the driving transistor, wherein a gate potential of the driving transistor is set to be lower than a potential of the data signal during the data program operation.

9. A pixel circuit, comprising:
a driving transistor connected to a light-emitting element; and
a capacitor connected to a gate of the driving transistor, wherein a threshold voltage of the driving transistor is compensated during a first period based on a first voltage, the first voltage based on a power supply voltage, wherein the gate of the driving transistor is set to a second voltage during a second period, the second voltage based on data voltage stored in the capacitor, and wherein the first period is independent from the second period.

10. The pixel circuit as claimed in claim 9, wherein:
a data program operation is performed during the second period, and
the data program operation is performed independently from the threshold voltage compensation during the first period.

11. The pixel circuit as claimed in claim 9, wherein a data signal corresponding to the data voltage and the power supply voltage are received on a same signal line at different times.

12. The pixel circuit as claimed in claim 9, wherein a data signal corresponding to the data voltage and the power supply voltage are carried along different signal lines.

13. The pixel circuit as claimed in claim 9, wherein the driving transistor is in a diode-connected state during the first period.

14. The pixel circuit as claimed in claim 9, wherein a data signal is written to the gate of the driving transistor while the driving transistor is in a diode-connected state.

15. The pixel circuit as claimed in claim 9, wherein:
a potential of the gate of the driving transistors is lowered before the data voltage is stored in the capacitor, the gate potential lowered based on a difference between a set voltage and a bias voltage.

16. The pixel circuit as claimed in claim 15, wherein the data voltage stored in the capacitor is written to the gate of the driving transistor after the gate potential of the driving transistor is lowered.

17. The pixel circuit as claimed in claim 15, wherein the capacitor is connected between the driving transistor and a signal line that receives the bias voltage.

18. The pixel circuit as claimed in claim 9, wherein:
the gate of the driving transistor is set to an initial voltage during a third period which occurs before the first and second periods.

19. The pixel circuit as claimed in claim 9, wherein the capacitor stores the data voltage independently from a signal line carrying a data signal corresponding to the data voltage and the power supply voltage.

20. The pixel circuit as claimed in clam 9, wherein the pixel circuit has a total of four transistors including the driving transistor.
